(19) United States
(12) Patent Application Publication
(10) Pub. No.: US 2026/0288708 A1
(43) Pub. Date: Sep. 24, 2026

(54) CUSTOMIZABLE DISTILLATION FRAMEWORK FOR NL2SQL WITH LARGE LANGUAGE MODELS

(71) Applicant: Oracle International Corporation, Redwood Shores, CA (US)

(72) Inventors: Gioacchino Tangari, Sydney (AU); Cong Duy Vu Hoang, Wantirna South (AU); Duy Vu, Melbourne (AU); Steve Wai-Chun Siu, Melbourne (AU); Dalu Guo, Sydney (AU); Budhaditya Saha, Sydney (AU); Dai Quoc Nguyen, Raceview (AU); Thanh Tien Vu, Herston (AU); Yakupitiyage Don Thanuja Samodhye Dharmasiri, Melbourne (AU); Thanh Long Duong, Melbourne (AU); Anshuk Pal Chaudhuri, Bengaluru (IN); Prabhakara Reddy Munnangi, Hyderabad (IN); Subash Kumar Bhamidipati, Issaquah, WA (US)

(73) Assignee: Oracle International Corporation, Redwood Shores, CA (US)

(21) Appl. No.: 19/086,722

(22) Filed: Mar. 21, 2025

(51) Int. Cl. G06F 16/242; G06N 3/0475; G06N 3/08

(52) U.S. Cl. CPC G06F 16/2448; G06N 3/0475; G06N 3/08

(57) ABSTRACT

Techniques are disclosed herein for generating a distillation dataset to train a machine learning model for converting natural language to logical form. In one aspect, a method is disclosed that includes: accessing customization information comprising a set of reference natural language queries, generating a set of synthetic natural language queries based on the customization information and database schema information and generating a set of distillation training examples. Generating the set of distillation training examples can include generating a synthetic programming language query for each synthetic natural language query. Each distillation training example comprises (i) a synthetic natural language query, (ii) a database schema from the database schema information associated with the synthetic natural language query, and (iii) a synthetic programming language query corresponding with the synthetic natural language query. A machine learning model may be trained with the set of distillation training examples.

### FIELD

The present disclosure generally relates to transforming natural language to a logical form, and more particularly, to techniques for generating a distillation dataset for training a natural language to logical form model, enabling customizable SQL generation.

### BACKGROUND

The advent of database management systems has revolutionized the way large datasets are stored, managed, and queried. Traditional databases, such as relational databases, have become the backbone of many applications across various industries. These databases are structured to store data in tables, allowing for the organization and retrieval of information in a systematic manner. The efficiency and reliability of databases have made them indispensable in fields such as finance, healthcare, and e-commerce, where large volumes of data need to be managed with precision and speed.

Structured Query Language (SQL) has been the primary tool for interacting with relational databases. SQL allows users to perform a wide range of operations, including data insertion, updates, deletions, and complex queries to retrieve specific information. The power and flexibility of SQL have made it the standard language for database management. However, the effective use of SQL requires a certain level of expertise, as constructing accurate and efficient queries can be complex and challenging for users who are not well-versed in the language.

In recent years, there has been a significant development in the field of databases with the emergence of text-to-SQL systems. These systems are designed to bridge the gap between natural language and SQL, enabling users to interact with databases using plain, conversational language. Text-to-SQL systems leverage advanced natural language processing (NLP) techniques and machine learning algorithms to translate user queries expressed in natural language into SQL commands. This innovation has the potential to democratize access to databases, allowing users without specialized SQL knowledge to efficiently retrieve and manipulate data.

The integration of text-to-SQL systems into database management represents a significant advancement in making databases more accessible and user-friendly. By simplifying the interaction with databases, these systems can enhance productivity and reduce the learning curve associated with database management. As businesses and organizations continue to accumulate and rely on large datasets, the ability to easily and accurately query databases using natural language will become increasingly valuable. This disclosure presents data synthesis techniques related to generating a distillation dataset for training a natural language to SQL model to generate SQL customized towards customer expectations

### BRIEF SUMMARY

Machine learning techniques are disclosed herein (e.g., a computer implemented method, a system, non-transitory computer-readable medium storing code or instructions executable by one or more processors) for generating a distillation dataset for training a natural language to logical form model, enabling customizable SQL generation.

In some embodiments, a computer-implemented method includes accessing customization information comprising a set of reference natural language queries; generating, by one or more first generative artificial intelligence models, a set of synthetic natural language queries based on the customization information and database schema information, wherein each synthetic natural language query of the set of synthetic natural language queries is an augmented version of a reference natural language query of the set of reference natural language queries; generating, by one or more second generative artificial intelligence models, a set of distillation training examples based on the set of synthetic natural language queries, wherein generating the set of distillation training examples comprises: generating a synthetic programming language query for each synthetic natural language query of the set of synthetic natural language queries, and generating each distillation training example of the set of distillation training examples such that each distillation training example comprises: (i) a synthetic natural language query, (ii) a database schema from the database schema information associated with the synthetic natural language query, and (iii) a synthetic programming language query corresponding with the synthetic natural language query; and training a machine learning model with the set of distillation training examples to generate a trained machine learning model.

In some embodiments, generating the set of synthetic natural language queries comprises: extracting a subset of reference natural language queries from the set of reference natural language queries; identifying a training database schema based on the database schema information; generating a first prompt comprising the subset of reference natural language queries, a target question, the training database schema, and a natural language query generation instruction; and providing the first prompt as an input to the one or more first generative artificial intelligence models.

In some embodiments, the first prompt further comprises an irrelevant natural language query associated with one or more irrelevant training examples.

In some embodiments, generating a synthetic programming language query for each synthetic natural language query comprises: constructing a second prompt, wherein the second prompt comprises a synthetic natural language query of the set of synthetic natural language queries, a database schema associated with the synthetic natural language query, and a programming language query generation instruction; generating, based on the second prompt and using the one or more second generative artificial intelligence models, the synthetic programming language query associated with the synthetic natural language query; and generating a description of the synthetic programming language query.

In some embodiments, the method further includes prior to training the machine learning model, filtering the set of distillation training examples to generate a filtered set of distillation training examples, wherein the filtering comprises: performing pattern-based filtering on the set of distillation training examples, wherein the pattern-based filtering comprises removing, from the set of distillation training examples, one or more distillation training examples comprising a synthetic programming language query with a syntax error; performing execution-based filtering on the set of distillation training examples, wherein the execution-based filtering, for each distillation training example of the set of distillation training examples, comprises: executing a synthetic programming language query included in the distillation training example on a database, and when executing the synthetic programming language query on the database fails, removing the distillation training example from the set of distillation training examples; and performing quality evaluation filtering, by one or more third generative artificial intelligence models, on the set of distillation training examples, wherein the quality evaluation filtering comprises performing a quality evaluation on each distillation training example of the set of distillation training examples and removing one or more irrelevant training examples from the distillation dataset, wherein the filtered set of distillation training examples is used to train the machine learning model.

In some embodiments, the quality evaluation comprises: determining, by the one or more third generative artificial intelligence models, a correctness score for the synthetic programming language query based on the synthetic natural language query; and determining a relevance of the distillation training example based on the set of reference natural language queries.

In some embodiments, the method further includes receiving an input from a user, the input comprising a natural language component; converting the input into a prompt, wherein the prompt comprises an instruction, a database schema associated with the natural language component, and an utterance associated with the natural language component; transmitting the prompt to the trained machine learning model; receiving, from the trained machine learning model, a programming language query corresponding to the utterance based at least in part on the prompt; executing the programming language query on a database to obtain a query result; and providing the query result to the user.

Some embodiments include a system that includes one or more processors; and one or more computer-readable media storing instructions which, when executed by the one or more processors, cause the system to perform part or all of the operations and/or methods disclosed herein.

Some embodiments include one or more non-transitory computer-readable media storing instructions which, when executed by one or more processors, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 depicts a simplified diagram for an example NL2SQL tool, according to various embodiments.

FIG. 2 depicts a simplified diagram for an example generative AI SQL agent system, according to various embodiments.

FIG. 3 depicts a simplified diagram for an example generative AI SQL agent, according to various embodiments.

FIG. 4 depicts a simplified block diagram for training, testing, and producing an NL2SQL model, according to various embodiments.

FIG. 5 depicts a simplified block diagram for a customizable distillation system for synthesizing distillation data to train an NL2SQL model, according to various embodiments.

FIG. 6 depicts a simplified block diagram for a natural language generation subsystem for generating synthetic natural language queries for an NL2SQL distillation system, according to various embodiments.

FIG. 7 depicts a simplified block diagram for a SQL generation subsystem for generating training examples containing synthetic SQL completions for an NL2SQL distillation system, according to various embodiments.

FIG. 8 depicts a simplified block diagram for a filtering system for filtering an NL2SQL distillation dataset, according to various embodiments.

FIG. 9 is a flowchart illustrating a process for generating a set of distillation training examples to train a machine learning model for transforming natural language to programming language, according to various embodiments.

FIG. 10 is a block diagram illustrating one pattern for implementing a cloud infrastructure as a service system according to certain embodiments.

FIG. 11 is a block diagram illustrating another pattern for implementing a cloud infrastructure as a service system according to certain embodiments.

FIG. 12 is a block diagram illustrating another pattern for implementing a cloud infrastructure as a service system according to certain embodiments.

FIG. 13 is a block diagram illustrating another pattern for implementing a cloud infrastructure as a service system according to certain embodiments.

FIG. 14 is a block diagram illustrating an example computer system according to certain embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### Introduction

In recent years, the amount of data powering different industries and their systems has been increasing exponentially. A majority of business information is stored in the form of relational databases that store, process, and retrieve data. Databases power information systems across multiple industries, for instance, consumer tech (e.g., orders, cancellations, refunds), supply chain (e.g., raw materials, stocks, vendors), healthcare (e.g., medical records), finance (e.g., financial business metrics), customer support, search engines, and much more. It is imperative for modern data-driven companies to track the real-time state of its business in order to quickly understand and diagnose any emerging issues, trends, or anomalies in the data and take immediate corrective actions. This work is usually performed manually by analysts who compose complex queries in query languages (e.g., database query languages such as declarative query languages) like SQL, PGQL, logical database queries, API query languages such as GraphQL, REST, and so forth. Composing such queries can be used to derive insightful information from data stored in multiple tables. These results are typically processed in the form of charts or graphs to enable users to quickly visualize the results and facilitate data-driven decision making.

Although common database queries (e.g., SQL queries) are often predefined and incorporated in commercial products, any new or follow-up queries still need to be manually coded by the analysts. Such static interactions between database queries and consumption of the corresponding results require time-consuming manual intervention and result in slow feedback cycles. It is vastly more efficient to have non-technical users (e.g., business leaders, doctors, or other users of the data) directly interact with the analytics tables via natural language (NL) queries that abstract away the underlying query language (e.g., SQL) code. Defining the database query requires a strong understanding of database schema and query language syntax and can quickly get overwhelming for beginners and non-technical stakeholders. Efforts to bridge this communication gap have led to the development of a new type of processing called natural language interfaces for databases (NLIDB). This natural search capability has become more popular over recent years as companies are developing deep-learning approaches for natural language to logical form (NL2LF) such as natural language to SQL (NL2SQL).

Logical form can refer to (i) programming query languages, (ii) intermediate forms, and/or (iii) programming languages. Programming query languages can include database query languages, and examples of programming query languages include, but are not limited to, SQL, PQL, GraphQL, SPARQL, and the like. Intermediate forms can refer to machine-oriented languages and/or meaning representation languages (MRLs) such as OMRL, AMRL, and the like. Examples of programming languages include, but are not limited to, Python, C++, Java, Ruby, and the like. NL2SQL seeks to transform natural language questions to SQL, allowing individuals to run unstructured queries against databases. The converted SQL could also enable digital assistants such as chatbots and others to improve their responses when the answer can be found in different databases or tables with different schemas.

In some instances, NL2SQL transforms natural language to SQL using generative artificial intelligence models such as large language models (LLMs). An LLM is a type of artificial intelligence (AI) that is trained to understand, generate, and manipulate human language (e.g., text data) in a coherent and contextually relevant manner. LLMs have resulted in significant progress in natural language processing tasks such as text-to-code (e.g., text-to-SQL), text generation and translation, and sentiment analysis. Due to their attention mechanisms and deep neural architectures, LLMs excel at capturing nuanced language patterns and correlations in massive volumes of text data. LLMs are designed to predict the next word or token in a sequence of text by computing a probability distribution over a fixed vocabulary for the next token based on the context of the preceding tokens. The prediction is achieved through a series of self-attention mechanisms incorporated in the LLMs that assign varying degrees of importance to different parts of the input sequence that enable the LLMs to make informed predictions. LLMs generate contextually appropriate and coherent text by learning a fixed vocabulary from enormous text corpora and predicting which token included in the fixed vocabulary should be the next token in an output sequence.

While LLMs may excel at natural language processing tasks such as text-to-code, LLM outputs are often generic based on the pattens captured within the massive volumes of text data used to train the LLM. However, users (e.g., customers) of an NL2SQL service may want outputs generated by an NL2SQL model to be relevant to their specific expectations or requirements. As an example, a user may have certain preferences for SQL queries related to date-time handling or financial analytics according to how data is stored within a database they manage. When using an NL2SQL service, the user may want the NL2SQL model to generate SQL queries that match their preferences for date-time handling rather than receiving generic SQL statements from the model and correcting the generated SQL queries to match their requirements. Out-of-the-box or pre-trained LLMs, however, may produce low accuracy and may not perform well on specific user cases.

To meet user expectations, LLMs may be provided with a prompt at runtime that includes instructions indicating specific syntax or preferences that should be reflected in generated SQL queries. With additional instructions in a prompt, an LLM may generate better SQL statements that follow expectations described in the prompt. However, for LLMs within an NL2SQL production environment, adding additional instructions to a prompt may be infeasible and challenging. Adding instructions to a prompt can result in longer prompts and contexts, which can increase the number tokens needed to process a prompt, thereby increasing computational resources expended in running a model. Longer prompts can also increase inference latency and deployment costs due to increased model response times.

Further, the natural language understanding (NLU) and instruction-following capabilities of an LLM may be constrained by model size and the number of parameters used by the LLM. Within a model, parameters can act as weights and biases in neural network layers that indicate feature importance and adjust outputs of neurons within the network. Parameters are adjusted during training based on a calculated training loss and can help an LLM understand relationships between words and/or tokens. When generating text, LLMs use parameters learned during training to predict the next word or token. A greater number of parameters used by an LLM can help the LLM better capture nuanced language patterns and complex relationships in text data such as instructions within a prompt. As such, smaller LLMs may not provide desired outputs due to limited instruction-following capabilities. In some examples, the number of parameters in an LLM can range from hundreds of thousands of parameters to trillions of parameters. For the purposes of this disclosure, a large LLM is defined as an LLM with substantially 10 billion parameters or more and a small LLM is defined as an LLM with less than substantially 10 billion parameters. However, it should be understood that various other definitions of large and small LLMs may be applicable without departing from the spirit and scope of the present disclosure so long as one of ordinary skill in the art would be able to determine the operational differences and/or limitations in models having said number of parameters (e.g., large being >or =to 15 billion parameters and small being <5 billion). As used herein, the terms “substantially,” “approximately” and “about” are defined as being largely but not necessarily wholly what is specified (and include wholly what is specified) as understood by one of ordinary skill in the art. In any disclosed embodiment, the term “substantially,” “approximately,” or “about” may be substituted with “within [a percentage] of” what is specified, where the percentage includes 0.1, 1, 5, and 10 percent.

Production environments hosting an NL2SQL service may be limited to deploying a small LLM as an NL2SQL model. Beyond increased latency related to parameter processing, running large LLMs can increase computational resource requirements including but not limited to hardware, storage, and memory, thereby increasing associated costs. For example, large LLMs typically use high-performance computing resources such as graphic processing units (GPUs) and tensor processing units (TPUs) to handle large computations and accelerate computational tasks. Further, loading and storing large numbers of parameters can significantly increase RAM and/or VRAM usage.

To achieve similar performance to a large LLM, a small LLM may be trained to meet user requirements by fine-tuning a pre-trained model with a dataset of training examples demonstrating desired SQL statements that follow user requirements. Larger datasets (e.g., on the scale of ten thousand training examples within the dataset) used to fine-tune a model can improve accuracy with a small LLM. Generating such datasets using manual data annotation, however, may be challenging due to the amount of time and human resources associated with manual data annotation.

To address these challenges and others, techniques are disclosed herein for distilling NL2SQL knowledge from a large LLM for training a small LLM to generate SQL statements customized towards user expectations. Knowledge distillation can include data synthesis utilizing a larger model and fine-tuning a smaller model using the synthetic distilled data. The data synthesis task can incorporate customization information reflecting user expectations and requirements as guidance to produce large distillation datasets that include training examples comprising a prompt and SQL completion. Data-generator LLMs (large LLMs) are prompted to produce more relevant and high-quality SQL data using customization information in the form of reference examples for synthetic NL questions and instructions for user SQL expectations. Using training examples generated by the large LLMs, a small LLM can be trained to meet user needs and deployed within an NL2SQL service without the associated computational and latency costs of deploying a large LLM. While the techniques described herein refer specifically to SQL generation, the distillation framework may be used in other contexts to generate other types of logical forms as described above (e.g., Python, C++, RDML, etc.).

Embodiments disclosed herein decouple the synthesis of NL examples and SQL examples and may apply several large LLMs at one or more stages of a customizable distillation framework to generate a large dataset of new NL questions and SQL completions. Decoupling NL and SQL generation can help scale up results, increase data diversity, and mitigate specific gaps within a specific LLM. As an example, some LLMs may be stronger than other LLMs for a specific Oracle SQL construct and weaker for other constructs. Using a combination of LLMs may reduce inaccuracies across SQL constructs. In certain instances, a filtering stage can be implemented to refine the quality of generated data and remove generated examples that contain errors, do not conform to user needs or are nonexecutable.

### Overview of Agents and NL2SQL Framework

An agent (also referred to as a skill, chatbot, chatterbot, talkbot, digital assistant, or the like) is a computer program that can perform conversations with end users. The agent can generally respond to natural-language messages (e.g., questions or comments) through a messaging application that uses natural-language messages. Enterprises may use one or more agent systems to communicate with end users through a messaging application. The messaging application, which may be referred to as a channel, may be an end user preferred messaging application that the end user has already installed and familiar with. Thus, the end user does not need to download and install new applications in order to chat with the agent system. The messaging application may include, for example, over-the-top (OTT) messaging channels (such as Facebook Messenger, Facebook WhatsApp, WeChat, Line, Kik, Telegram, Talk, Skype, Slack, or SMS), virtual private assistants (such as Amazon Dot, Echo, or Show, Google Home, Apple HomePod, etc.), mobile and web app extensions that extend native or hybrid/responsive mobile apps or web applications with chat capabilities, or voice based input (such as devices or apps with interfaces that use Siri, Cortana, Google Voice, or other speech input for interaction).

End users may interact with the agent system through a conversational interaction (sometimes referred to as a conversational user interface (UI)), just as interactions between people. In some cases, the interaction may include the end user providing a utterance such as query: “Please retrieve all invoices greater than ten thousand dollars for the last four years for Customer Y”, to the agent, and the agent responding with a natural language response for the query based on translation of the user's natural language query to a SQL query and execution of the SQL query on an appropriate database.

In some embodiments, the agent system may intelligently handle end user interactions without interaction with an administrator or developer of the agent system. For example, an end user may send one or more messages to the agent system in order to achieve a desired goal. A message may include certain content, such as natural language text, audio, image, video, or other method of conveying a message. In some embodiments, the agent system may convert the content into a standardized logical form (e.g., a SQL query). The agent system may also prompt the end user for additional input parameters or request other additional information. In some embodiments, the agent system may also initiate communication with the end user, rather than passively responding to end user utterances. Described herein are various techniques for identifying an explicit or implicit invocation of an agent system and determining an input for the agent system being invoked.

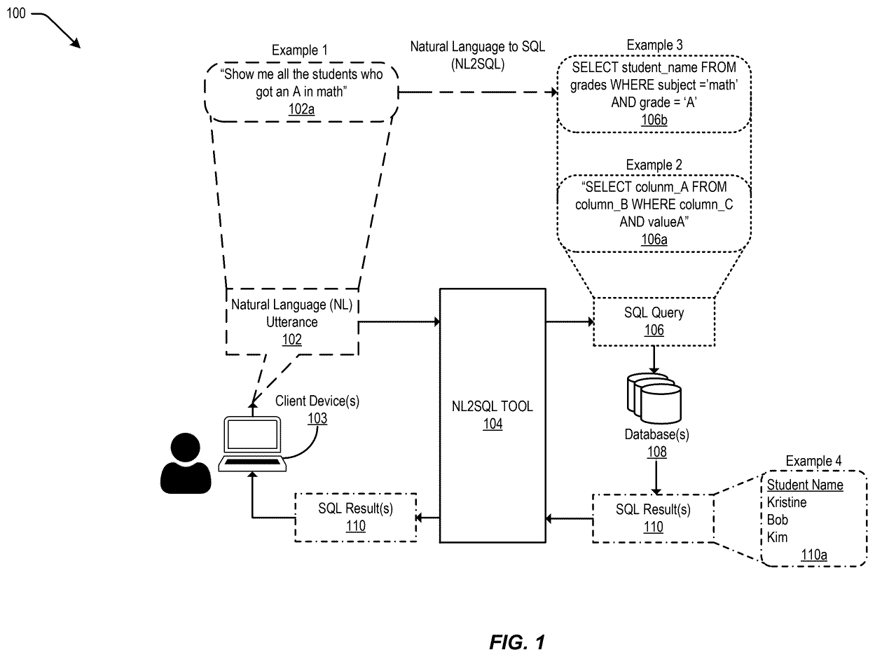

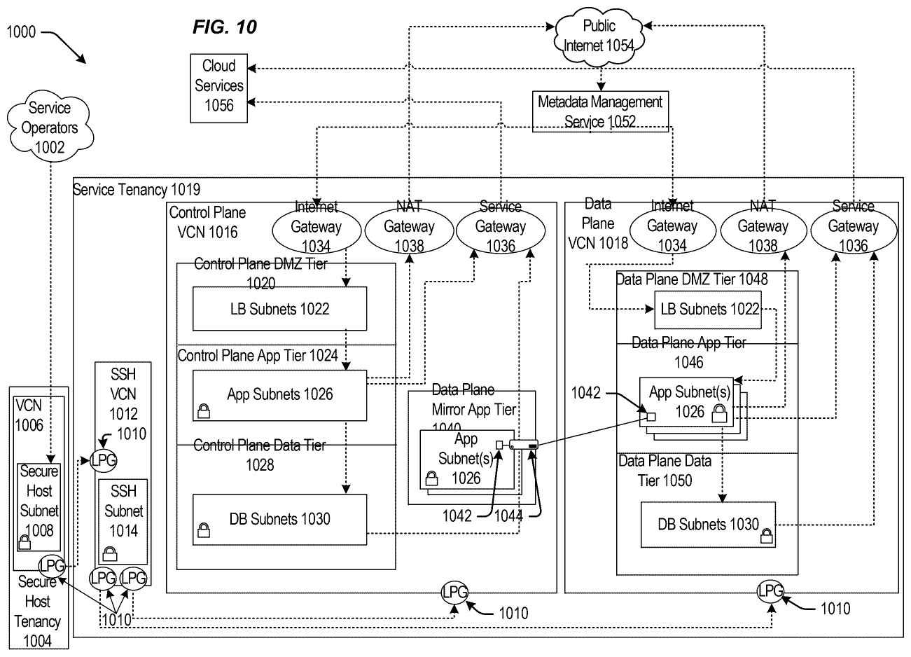

FIG. 1 depicts a simplified diagram of an environment 100 incorporating an exemplary NL2SQL tool, according to various embodiments. Environment 100 includes an NL2SQL tool 104 that enables users 101 to receive (i) a translated version of a natural language utterance 102 (e.g., a natural language query translated into a given programming language such as SQL), and/or (ii) a result of executing an action related to a natural language utterance 102 (e.g., a natural language query translated into a given programming language such as SQL, which is then executed on a database to retrieve a result for query). As shown in FIG. 1, the NL2SQL tool 104 is configured to generate a SQL query 106 and one or more SQL query result(s) 110 based on the provided natural language utterance 102, however other examples may implement tasks in addition to or alternative to SQL query generation (e.g., schema checking, schema linking, sentence completion, extraction of key information, debugging, and other SQL related tasks). The NL2SQL tool 104 can be implemented using software only, hardware only, firmware only, or any combination of hardware, software, and/or firmware. In some instances, the environment 100 is part of an Infrastructure as a Service (IaaS) cloud service (described in more detail with respect to FIGS. 10-14) and the NL2SQL tool can be implemented as part of the IaaS by leveraging the scalable computing resources and storage capabilities provided by the IaaS provider to process and manage large volumes of data and complex computations. This setup can allow the NL2SQL tool 104 to deliver real-time, responsive interactions while ensure high availability, security, and performance scalability to meet varying demand levels. The NL2SQL tool 104 can be embodied or implemented in various physical systems or devices, such as in a computer, a mobile phone, a watch, an appliance, a vehicle, and the like. For the purposes of this example, the NL2SQL tool 104 generates and accepts queries related to SQL, but it should be understood that the techniques described herein are not limited to SQL and the NL2SQL tool 104 can be configured as any other NL2LF tool capable of generating queries and statements using other programming languages (e.g., PRQL, GraphQL, WebAssembly, Python, R, Java, N1QL, and the like).

As illustrated in FIG. 1, a user 101 provides a user input to the NL2SQL tool 104. The user input can be or can include a natural language utterance 102. The natural language utterance can be in text form, such as when the user types a sentence, a question, a text fragment, or phrase and provides it as an input to the NL2SQL tool 104 via client device(s) 103. The client devices(s) 103 can be configured to communicate with the NL2SQL tool 104, provide the natural language utterance 102 to the NL2SQL tool 104 and receive outputs from the NL2SQL tool 104. In some implementations, the natural language utterance 102 can be in speech form, which may be converted to text form and provided to the NL2SQL tool 104. As an example, a natural language utterance 102 such as 102a “Show me all the students who got an A in math” can be spoken by the user 101 and the NL2SQL tool 104 may be configured as a standalone or via a plug-in, or make use of some other audio-to-text translator, configured to translate the audio into text for further processing.

The NL2SQL tool 104 may be or may make use of one or more generative artificial intelligence models such as LLMs configured to generate a SQL query 106 (e.g., 106a or 106b) based on the natural language utterance 102. The NL2SQL tool 104 may receive a prompt including the natural language utterance 102 to generate a SQL query 106 that it is relevant to the user 101 preferences. In some implementations, the user 101 and/or client device 103 generate a prompt including the natural language utterance 102 before providing the prompt to the NL2SQL tool 104. In other implementations, the NL2SQL tool 104 receives the natural language utterance 102 and generates the prompt itself, e.g., populates slots of a prompt template, before providing the prompt to a trained generative artificial intelligence model.

The NL2SQL tool 104 converts the natural language utterance 102 (as in example 1 depicted in FIG. 1) to the SQL query 106. The NL2SQL tool 104 may consider schema information corresponding to one or more databases 108 to generate the SQL query 106. The SQL query 106 (as in examples 2 or 3 depicted in FIG. 1) may be executed on database(s) 108 to obtain a SQL result 110. As a non-limiting example, SQL result 110 can be a list of students who got an A in math based on a generated SQL query 106. The SQL result(s) 110 can be provided back to the user 101 by the NL2SQL tool 104. In some instances, the SQL result(s) 110 are reported back to the user 101 as raw output. In other instances, the SQL result(s) 110 are reported back to the user 101 as part of a natural language response (e.g., a summary) generated by the one or more generative artificial intelligence models in response to the natural language utterance 102. In other instances, the SQL result(s) 110 are reported back to the user 101 as part of a natural language response (e.g., a summary) generated by the one or more generative artificial intelligence models and/or with a visualization (e.g., a bar chart, pie chart, table, or the like) generated by one or more generative artificial intelligence models and/or analytic subsystems in response to the natural language utterance 102. The user 101 may receive the SQL result(s) 110 through the client device(s) 103. Additionally or alternatively, the NL2SQL tool 104 may provide the SQL query 106 to the user(s) via some other means such as an email communication, SMS message, or other type of notification receivable on one or more other computing devices. In some implementations, the SQL query 106 is provided to the user(s) in addition to or without running the SQL query 106 on the database(s) 108 to obtain SQL result(s) 110 (e.g., as part of a feedback request to validate the SQL query 106).

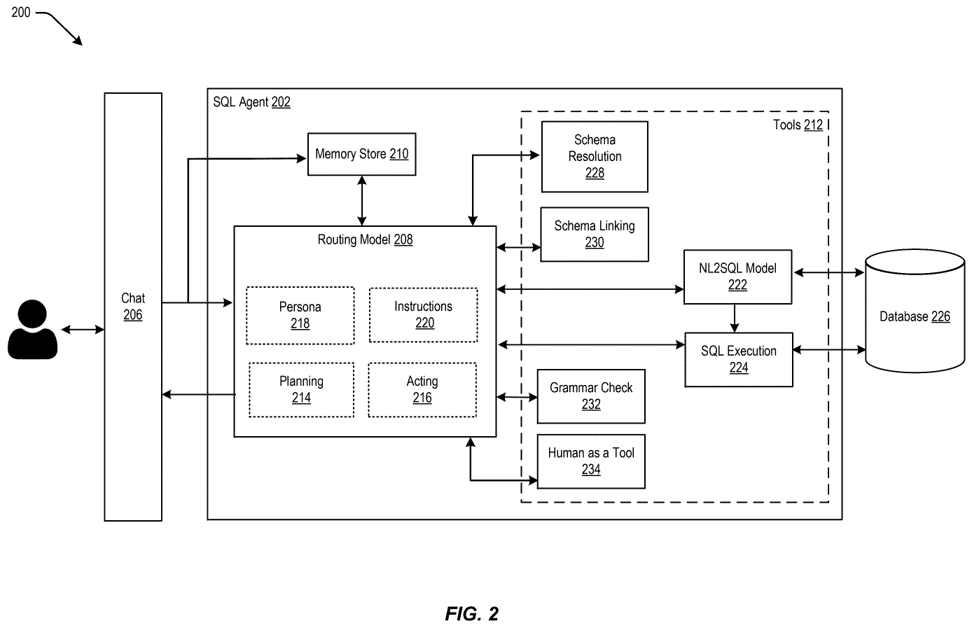

FIG. 2 is a simplified block diagram of a SQL agent system 200 according to certain embodiments. SQL agent system 200 is a computing system that can be implemented in software only, hardware only, firmware only, or any combination of hardware, software, and/or firmware. The SQL agent system 200 can convert natural language questions into SQL to help users complete their data related tasks by leveraging the power of generative artificial intelligence such as LLMs. In addition to their language capabilities (e.g.: sentence completion, summarization, extraction of key information from text passages), generative artificial intelligence can generate SQL statements. The purpose of the SQL agent system 200 is to enable users to talk to their databases with the least amount of effort. This may include the SQL agent system 200 interpreting user requests in natural language, reviewing database schema, implementing schema linking (i.e. identify names of tables and columns in natural language questions), generating SQL queries and even executing the SQL statements. In certain embodiments, the SQL agent system 200 can be used to implement one or more tools related to SQL generation, execution, and/or review (e.g., NL2SQL tool 104 as described with respect to FIG. 1). The SQL agent system 200 can include a SQL agent 202 capable of converting a natural language question into a SQL query.

A user 204 can participate in a chat 206 (also described herein as a conversation or an interaction) with the SQL agent 202. The user 204 may interact with the chat 206 via a user interface such as a graphical user interface or conversational user interface. As an example, the user 204 may provide a user input to the SQL agent 202 via a user interface element such as a chat window. The chat 206 can include one or more inputs from the user 204 and one or more responses from the SQL agent 202. The chat 206 may correspond to one or more chat sessions between the user 204 and the SQL agent 202. During the chat 206, the user 204 provides a natural language utterance that can be processed by the SQL agent 202. The natural language utterance can include a question related to a database or SQL generation.

One or more user inputs provided by the user 204 via the chat 206 are provided to the SQL agent 202. Included in the SQL agent 202 are a routing model 208, a memory store 210 and tools 212. The routing model 208 and memory store 210 receive user inputs such as natural language utterances from the chat 206. The memory store 210 can store a chat history for the user 204 and contextual information related to the user 204, the chat 206, and/or other pieces of information relevant to the NL2SQL operations such as in-context examples, APIs, external knowledge, and the like. The tools 212 can include functions, APIs, and trained machine learning models that can be used by the SQL agent 202 to interact with external systems (e.g., database 226, external knowledge bases) and/or generate SQL statements.

The routing model 208 may be or may make use of one or more generative artificial intelligence models such as LLMs. The routing model 208 can include a planning 214 component and an acting 216 component (i.e., trained task). Planning 214 includes generating a plan that is comprised of a sequence of steps for execution (acting 216), which includes executing the steps in a generated plan using one or more tools 212. In some examples, the routing model 208 may retrieve contextual information related to the user 204 and/or chat 206 from the memory store 210 during planning 214 to improve plan generation. Planning 214 may further include determining a new plan based on a result produced by acting 216 and the execution of a previous plan.

One or more tools 212 supported by the SQL agent 202 may be LLM-based tools configured to receive a prompt and generate a result based at least in part on the prompt. As an example, the tools 212 can include an LLM-based NL2SQL model 222 that generates a SQL statement based on a prompt including a natural language utterance provided by the user 204 (e.g., as described in FIG. 1). In some instances, the routing model 208 can generate a prompt based on a natural language utterance received from the user 204. In some examples, steps for generating a prompt can be included in a plan generated by planning 214 and the prompt may be generated by acting 216. A prompt can include a persona 218 and instructions 220. The persona 218 can be selected from a set of available personas (see Table 1 for a non-limiting list of exemplary personas). Including the persona 218 in a prompt for an LLM may improve accuracy of generated responses and customize responses generated by an LLM to the needs of the user 204. In some examples, planning 214 may select a tool from the tools 212 based on the persona 218.

TABLE 1

| Example Persona | Example Description |
|---|---|
| Junior Developer | A user having limited to no experience in writing |
| | SQL queries that requires assistance in writing and |
| | optimizing SQL queries. |
| Expert Developer | A user with several years of experience writing |
| | SQL queries. |
| Business Analyst | A user with strong context about the needs of a |
| | company and wants quick data insights without |
| | deep SQL knowledge. |
| Data Scientist | A user focused on extracting and analyzing data |
| | efficiently. |

Instructions 220 describe the knowledge bases and tools available to the SQL agent 202. Instructions 220 can be included in a prompt for LLM-based tools and may guide a tool to generate a response relevant to preferences of user 204. Additionally, or alternatively, the prompt can include a table schema, description of columns in the table schema, context, in-context examples, additional instructions, a user question, or any combination thereof. In some examples, context may include contextual information related to the user 204 and/or chat 206 history and may be retrieved from the memory store 210 by the routing model 208. The prompt may further include database schema information corresponding to a database 226.

The routing model 208 may provide the generated prompt to a tool from the tools 212 selected by planning 214. As an example, the NL2SQL model 222 receives a prompt provided by the routing model 208 and generates a SQL query based on the prompt. The NL2SQL model 222 can be trained to convert a natural language question into a SQL query to help the user 204 complete data related tasks. In some examples, the SQL query generated by the NL2SQL model 222 is returned to the user 204 via the chat 206. Additionally, or alternatively, the generated SQL query is provided to a SQL execution 224 tool that is configured to execute SQL queries on the database 226. SQL execution 224 may receive a SQL result from the database 226 and provide the SQL result to the routing model 208. The routing model 208 may provide the SQL result to the user 204 via the chat 206. In some implementations, the routing model 208 may identify an error in the SQL result or determine the SQL query and/or result does not correspond to user 204 needs and generate new plan using planning 214 to correct the error or generate a new SQL query.

Additional examples of tools include, but are not limited to, schema resolution 228, schema linking 230, grammar check 232, and human as a tool 234. Schema resolution 228 may be configured to check for and/or fix any errors within a SQL statement. The SQL agent 202 may use schema resolution 228 after a SQL query is generated by the NL2SQL model 222. Schema linking 230 may be configured to identify proper references to schema values (e.g., tables, columns, condition values) based on schema information and query patterns. Schema linking 230 can include content-based schema linking for mapping values, and name-based schema linking for mapping table and column names for SQL generation. For large schemas, retrieval augmented generation (RAG)-based schema linking may be implemented to retrieve a relevant subset of the schema. Schemas can be stored in a knowledge base (e.g., memory store 210) and relevant schema information can be retrieved based on a natural language query provided by the user 204. In some implementations, the knowledge base includes external data stores and schema linking 230 can include performing a web search to identify relevant schema. The SQL agent 202 may be unable to resolve ambiguities during schema linking 230. In such examples, the SQL agent 202 can ask the user 204 clarifying questions to resolve the ambiguities and/or acquire missing information to resolve the ambiguities.

Also included in the tools 212 is a grammar check 232 that can review grammar of generated statements. Tools 212 can also include human as a tool 234. The SQL agent 202 may seek human input for clarification and disambiguation. Human as a tool 234 may be used to supplement one or more additional tools of the set of tools 212 with human input or intervention. Human as a tool 234 can include asking the user 204 or another user such as a developer for information for correcting previous generations.

The SQL agent 202 may use a singular tool or a combination of tools 212 to generate a response to the user 204. The routing model 208 can select a tool and/or generate a prompt for the selected tool based on a natural language utterance received via the chat 206. The routing model 208 receives an output from the selected tool based on the prompt and/or context provided to the selected tool. In some implementations, the output generated by the selected tool is provided to the user 201 via the chat 202 as received by the routing model 208 (i.e., without additional modifications to the output).

In some implementations, the routing model 208 responds to the user 204 which provided the original query as part of a two-way conversation (e.g., via chat 206). The natural language response may include a natural language component (e.g., answers to questions, information, etc.) and/or a logical form component (e.g., a SQL query). In some embodiments, the routing model 208 may generate a natural language response containing the output generated by the selected tool. The routing model 208 may be configured to generate the natural language response and/or may use a response generation tool to generate the natural language response. The natural language response can be provided to the user 201 via the chat 206. In some implementations, the SQL agent 202 may provide a visualization of the generated output through a plot, table, graph, and the like, via the chat 206. As a particular example, the SQL agent 202 can use the schema linking 230 tool to identify names of table and columns in a natural language utterance (which is an example of NL utterance 102 with respect to FIG. 1) provided by the user 204 and then generate a SQL query using the NL2SQL model 222 based on the identified table and column names. The SQL query may be provided to the user 201 via the chat 202 as generated by the NL2SQL model 222. In some implementations, the routing model 208 may generate a natural language response containing the SQL query and provide the natural language response to the user 201 via the chat 202.

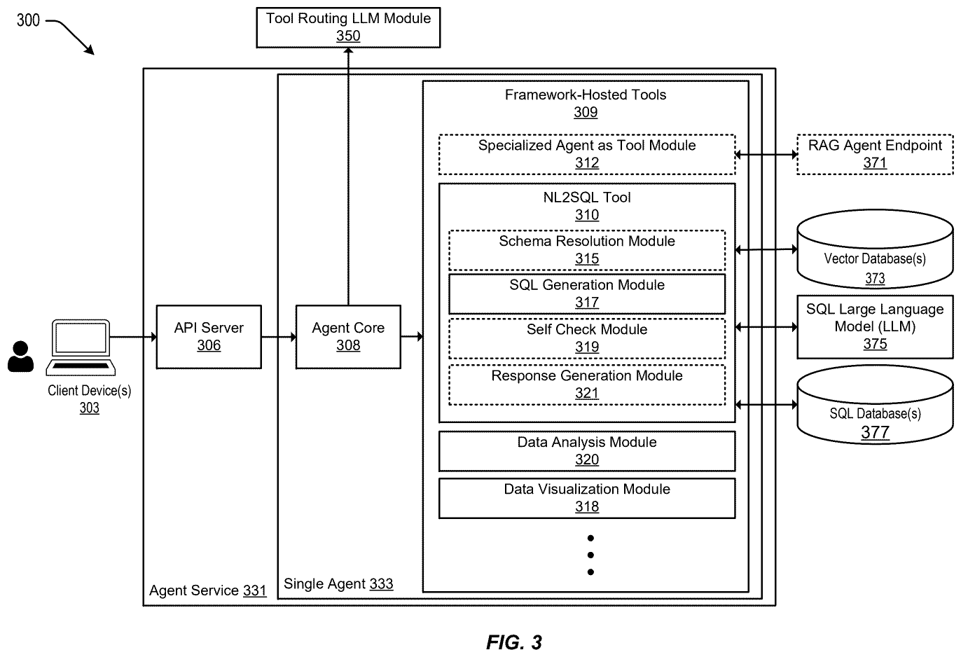

FIG. 3 depicts a simplified diagram 300 for an example generative AI SQL agent, according to various embodiments. As discussed in regard to FIGS. 1 and 2, user(s) (e.g., users 101 or 204) may use client device(s) 303 to submit a NL utterance and/or question to an agent service 331 by way of an API server 306. The API server 306 may be a software, hardware, and/or firmware component that enables one or more applications (e.g., cloud applications) to enable communication as an intermediary between the client device(s) 303 and the agents. The API server 306 may identify a specific agent (e.g., single agent 333), or multiple agents, to handle the instance (e.g., by agent specialty or user preference) and select an agent core 308. The agent core 308 may be configured with pass-through routing or, if additional tools are included in the agent, a specific routing (e.g., ReAct routing) may be implemented. The agent core 308 may handle multi-step (or iterated) SQL resolution, generation, and/or execution. By way of a non-limiting example, in analytical use cases using unique software packages (e.g., Oracle™ Analytics Cloud (OAC), Tableau™, etc.), a single analytical dashboard may generate multiple SQL queries using output from previous inputs (e.g., by way of Churn analysis, Funnel analysis, cohort analysis, etc.). The agent core 308 may access a tool routing LLM module 350 in order to identify, select, utilize, and/or train one or more LLM(s) that may suitably apply to the utterance received from the client device(s) 303.

The agent core 308 may include one or more framework-hosted tools 309 for addressing various functions. For example, the framework-hosted tools 309 may include a specialized agent as tool module 312 which may be in communication with a retrieval augmented generation (RAG) endpoint 371. The RAG endpoint 371 may improve an efficacy of one or more LLMs by suitably leveraging various sources of data. For example, retrieving data/documents relevant to the utterance (e.g., question, statement, task, etc.) and providing them as context for the LLM as either labeled or unlabeled data. The RAG endpoint 371 may provide support to the agent core and maintain up-to-date information based at least in part on other trained LLMs and/or agent cores (not depicted), and/or access domain-specific knowledge.

Included in the frame-work hosted tools 309 is a NL2SQL tool 310, which is an example of the NL2SQL model 218 with respect to FIG. 2. The NL2SQL tool 310 includes, without limitation, modules 315, 317, 319, and 321. Schema resolution module 315 may function to receive input from the client device(s) 303 requesting the NL2SQL tool 310 check one or more schema for any errors (e.g., syntax errors, sematic errors, etc.) and fix the errors (or recommend a fix). The agent core 308 may provide explanations to the client device(s) 303 about each fix performed. The explanations may be provided in natural language. In some examples, the NL2SQL tool 310 may attempt to automatically resolve the errors if possible and ask clarification questions (e.g., as output to the client device(s) 303) where suitably needed. If the error cannot be resolved, the error may be displayed to the user(s). As an example, the different types of errors that an agent core 308 (which is an example component of SQL agent 202 with respect to FIG. 2) may return can include syntax errors and semantic errors. The schema resolution module 315 may reference one or more vector database(s) 373 to obtain and/or store schema.

Also included in the NL2SQL tool 310 is a SQL generation module 317. The SQL generation module 317 may take the utterance received from the client device(s) 303 and construct a SQL query. To do this, the NL2SQL tool 310 may access one or more generative artificial intelligence models such as LLMs (e.g., SQL LLM 375) that may have been trained on generating SQL queries. An LLM may receive the utterance from the NL2SQL tool 310 and may translate the utterance into a relevant SQL query. The SQL generation module 317 may then pass the received SQL query from the LLM to one or more additional modules. For example, the SQL generation module 317 may pass the SQL query returned from the LLM to a response generation module 321. The response generation module 321 may append the SQL query (optionally along with information related to the utterance) and return the SQL query to the client device(s) 303. In addition, or alternatively, the response generation module 321 may pass the SQL query to one or more SQL database(s) 377 to retrieve information related to the utterance. The NL2SQL tool 310 may utilize a self-check module 319, which may function with any one or more of the other modules. The self-check module 319 may automatically try to resolve errors associated with the SQL query and/or LLM prompt containing the utterance. The self-check module 319 may ask clarifying questions to the client device(s) 303 and/or the LLM to resolve the errors.

The framework-hosted tools 309 includes data analysis module 320 and a data visualization module 318. Each of 320 and 318 may function with any of the modules of the framework-hosted tools 309 in order to analyze various analytics and display the various analytics. The analytics may include analysis of schema, SQL queries, LLM accuracy, recommendations, or suitable equivalents.

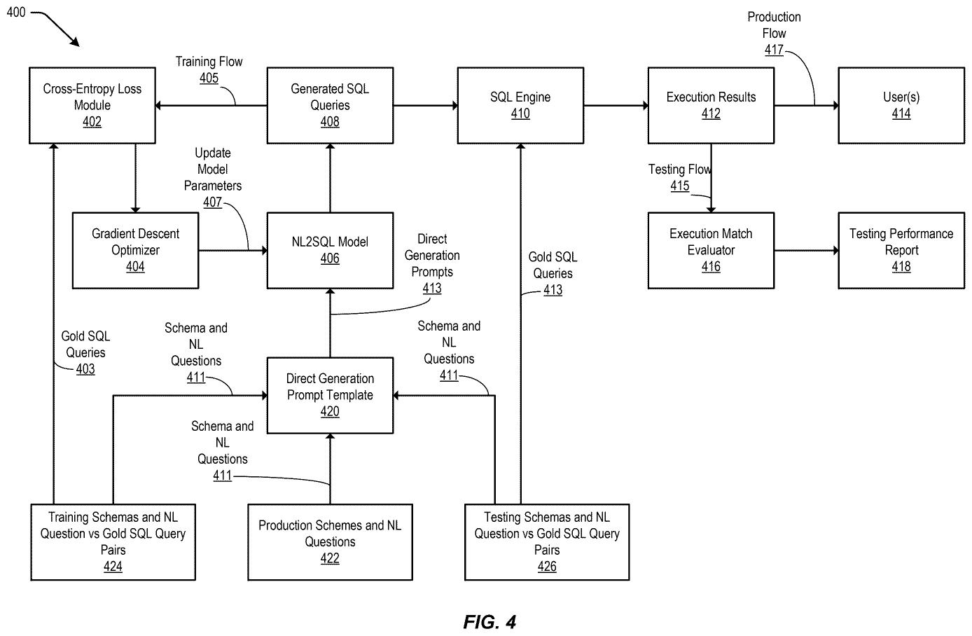

FIG. 4 depicts a simplified block diagram 400 for training, testing, and deployment or production of an NL2SQL Model, according to various embodiments. This simplified overview of training, testing, and inference depicts flows for a NL2SQL direct generation model (however it should be understood that similar steps could be implemented for a generation model that translates to an intermediate database query language which can be used to generate a query in a specific system query language or other for a generation model that translates to another programming language such as PRQL, GraphQL, WebAssembly, Python, R, Java, N1QL, and the like). A NL2SQL model is powered by a machine learning model (e.g., an LLM) configured to convert a NL utterance (e.g., a query posed by a user using an agent) into a logical form, for example, an intermediate database query language such as OMRL or a system query language format, such as SQL or PGQL. If an intermediate database query language format is used then the intermediate database query language can be used to generate a query in a specific system query language (e.g., SQL), which can then be executed for querying a system such as a database to obtain an answer to the user's utterance. If a system query language format is used, then the system query language can be directly executed for querying a system such as a database to obtain an answer to the user's utterance.

One goal of the NL2SQL model is to allow end users to interact with their systems, (e.g., SQL databases) through natural language rather than program specific language queries such as SQL queries. Using a NL2SQL service, users such as business analysts can extract information from their systems without thorough knowledge of a specific programming language and system schemas. The NL2SQL model is an LLM, which is an advanced type of artificial intelligence model designed to understand and generate human language. These models are trained on vast amounts of text data and leverage deep learning techniques to perform a variety of natural language processing tasks, such as text generation, translation, summarization, and answering questions. In the below description, the LLM (NL2SQL model) is designed and trained to convert natural language queries into SQL queries. This involves understanding the semantics of the natural language input, mapping it to the corresponding database schema, and generating a syntactically and semantically correct SQL query that can retrieve the desired information from the database. However, it should be understood that similar techniques could be implemented for other programming languages including other system query languages such as PGQL and/or other intermediate logical forms such as MRL or OMRL.

The input to the Natural Language-to-SQL (NL2SQL) model is a natural language question.

```
For example:
  “Get me the list of employees from Australia.”
The main output from the NL2SQL model is a SQL query.
For example:
  SELECT employee_id, employee_name FROM Employee WHERE country =
  ″Australia″.
Another important input to the NL2SQL model 406 is the database schema that helps the
model to identify relevant tables and columns in the SQL output construction.
For example:
  CREATE TABLE Employee (
  employee_id TEXT(12) NOT NULL,
  employee_name TEXT(100) NOT NULL,
  birth_date DATE NOT NULL,
  hire_date DATE NOT NULL,
  country TEXT(100),
  ...
  )
  CREATE TABLE JobTitle (
  ...
  )
  ...
```

Described herein is a pre-trained NL2SQL model developed based on instruction fine-tuning of LLMs to provide this NL2SQL direct generation capability, e.g., the mapping of (Database Schema, NL Question)→SQL Query. Below is the summary of how the NL2SQL direct generation capability is implemented via instruction fine-tuning.

Data to train a NL2SQL model includes multiple database schemas defined as SQL CREATE TABLE statements:

```
  • Table names
  • Column names and types
  • Primary and foreign keys
  • Other constraints
One Database Schema Example:
  CREATE TABLE aircraft (
    aid NUMERIC(9, 0),
    name TEXT(30),
    distance NUMERIC(6, 0),
    PRIMARY KEY (aid)
  )
  CREATE TABLE employee (
    eid NUMERIC(9, 0),
    name TEXT(30),
    salary NUMERIC(10, 2),
    PRIMARY KEY (eid)
  )
  CREATE TABLE certificate (
    eid NUMERIC(9, 0),
    aid NUMERIC(9, 0),
    PRIMARY KEY (eid, aid),
    FOREIGN KEY(aid) REFERENCES aircraft (aid),
    FOREIGN KEY(eid) REFERENCES employee (eid)
  )
  CREATE TABLE flight (
    flno NUMERIC(4, 0),
    origin TEXT(20),
    destination TEXT(20),
    distance NUMERIC(6, 0),
    departure_date DATE,
    arrival_date DATE,
    price NUMERIC(7, 2),
    aid NUMERIC(9, 0),
    PRIMARY KEY (flno),
    FOREIGN KEY(aid) REFERENCES aircraft (aid)
  )
```

Each database schema can be associated with multiple pairs of natural language questions and corresponding SQL queries.

Example of NL Question and corresponding SQL Query:

NL Question: “What is the name of the employee with salary greater than 100000 and
with the most certificates to fly planes more than 5000?”
SQL Query: “SELECT T1.name FROM employee AS T1 JOIN certificate AS T2 ON
T1.eid = T2.eid JOIN aircraft AS T3 ON T2.aid = T3.aid WHERE T3.distance > 5000
AND T1.salary > 100000 GROUP BY T1.eid ORDER BY count(*) DESC LIMIT 1”

Each question-query pair and its corresponding database schema are populated following a NL2SQL direct generation prompt template to create one direct generation prompt example:

Direction NL2SQL Generation Prompt Example:

```
Given an input Question, create a syntactically correct Oracle SQL query to run.
Pay attention to using only the column names that you can see in the schema description.
Be careful to not query for columns that do not exist. Also, pay attention to which column
is in which table.
Please double check the SQL query you generate.
DO NOT use alias in the SELECT clauses.
Only use the tables listed below.
CREATE TABLE aircraft (
  aid NUMERIC(9, 0),
  name TEXT(30),
  distance NUMERIC(6, 0),
  PRIMARY KEY (aid)
)
CREATE TABLE employee (
  eid NUMERIC(9, 0),
  name TEXT(30),
  salary NUMERIC(10, 2),
  PRIMARY KEY (eid)
)
CREATE TABLE certificate (
  eid NUMERIC(9, 0),
  aid NUMERIC(9, 0),
  PRIMARY KEY (eid, aid),
  FOREIGN KEY(aid) REFERENCES aircraft (aid),
  FOREIGN KEY(eid) REFERENCES employee (eid)
)
CREATE TABLE flight (
  flno NUMERIC(4, 0),
  origin TEXT(20),
  destination TEXT(20),
  distance NUMERIC(6, 0),
  departure_date DATE,
  arrival_date DATE,
  price NUMERIC(7, 2),
  aid NUMERIC(9, 0),
  PRIMARY KEY (flno),
  FOREIGN KEY(aid) REFERENCES aircraft (aid)
)
Question: What is the name of the employee with salary greater than 100000 and with the
most certificates to fly planes more than 5000?
SQL: “SELECT T1.name FROM employee AS T1 JOIN certificate AS T2 ON T1.eid =
T2.eid JOIN aircraft AS T3 ON T2.aid = T3.aid WHERE T3.distance > 5000 AND
T1.salary > 100000 GROUP BY T1.eid ORDER BY count(*) DESC LIMIT 1”
```

The prompt example can then be sent to the LLM model to generate the SQL query during training and testing phases. The gold (ground truth) SQL Query: “SELECT T1.name FROM employee AS T1 JOIN certificate AS T2 ON T1.eid=T2.eid JOIN aircraft AS T3 ON T2.aid=T3.aid WHERE T3.distance >5000 AND T1.salary >100000 GROUP BY T1.eid ORDER BY count (*) DESC LIMIT 1” is used to evaluate the generated SQL query using a loss function such as cross-entropy loss (e.g., using cross-entropy loss module 402) in training and a performance metric such as execution match in testing. For execution match, both gold and generated SQL queries are executed on the database using the SQL engine. Their result sets are compared to check if they are matched.

The training and testing flows start at either a training schemas and NL question versus (vs) gold SQL query pairs block 424 or a testing schemas and NL question versus gold SQL query pairs block 426, respectively, where training and testing data is collected (e.g., acquired or accessed). The data collection can include exploring various data sources such as public datasets, private data collections, or real-time data streams, depending on a project's needs. In some instances, a data source is a public or online repository of information or examples pertinent to a general or target domain space. Many domains have publicly available datasets provided by governments, universities, or organizations. For example, many government and private entities offer datasets on healthcare, environmental data, and more through various portals. For proprietary needs, data might be available through partnerships or purchases from private companies that specialize in data aggregation. In other instances, a data source is a private repository of information or examples pertinent to a general or target domain space. For example, a data source can be a storage device that stores various schemas and natural language questions (including labels for corresponding gold SQL queries 403, 413).

Preprocessing may be performed on the training and testing data (from 424, 426 respectively), serving as a bridge between raw data acquisition and effective model training. The primary objective of preprocessing is to transform raw data into a format that is more suitable and efficient for analysis, ensuring that the data fed into machine learning algorithms is clean, consistent, and relevant. This step can be useful because raw data often comes with a variety of issues such as missing values, noise, irrelevant information, and inconsistencies that can significantly hinder the performance of a model. By standardizing and cleaning the data beforehand, preprocessing helps in enhancing the accuracy and efficiency of the subsequent analysis, making the data more representative of the underlying problem the model aims to solve. At block 420, the preprocessing includes populating the training and testing data (e.g., schema and NL questions 411) into the direct generation prompt template (as described above) to create direct generation prompts 413 from which the NL2SQL model 406 generates SQL queries.

Once collected, generated, preprocessed, and/or labeled, the data may then be split into the training and testing datasets. The training and testing datasets may comprise the raw data and/or preprocessed data. The training and testing datasets are typically split into at least three subsets of data: training, validation, and testing. The training set is used to fit the model, where the machine learning model learns to make inferences based on the training data. The validation set, on the other hand, is utilized to tune hyperparameters and prevent overfitting by providing a sandbox for model selection. Finally, the test set serves as a new and unseen dataset for the model, used to simulate real-world application and evaluate the final model's performance. The process of splitting ensures that the model can perform well not just on the data it was trained on, but also on new, unseen data, thereby validating and testing its ability to generalize.

Various techniques can be employed to split the data effectively, with each method aiming to maintain a good representation of the overall dataset in each subset. A simple random split (e.g., a 70/20/10%, 80/10/10%, or 60/25/15%) is the most straightforward approach, where examples from the data are randomly assigned to each of the three sets. However, more sophisticated methods may be necessary to preserve the underlying distribution of data. For instance, stratified sampling may be used to ensure that each split reflects the overall distribution of a specific variable, particularly useful in cases where certain categories or outcomes are underrepresented. Another technique, k-fold cross-validation, involves rotating the validation set across different subsets of the data, maximizing the use of available data for training while still holding out portions for validation. These methods help in achieving more robust and reliable model evaluation and are useful in the development of predictive models that perform consistently across varied datasets.

At this stage, hyperparameters may also be acquired or set for the training and testing. The hyperparameters control the overall behavior of the models. Unlike model parameters that are learned automatically during training, hyperparameters are set before training begins and have a significant impact on the performance of the model. For example, in an LLM, hyperparameters include the learning rate, batch size, number of layers, number of attention heads, hidden layer size, dropout rate, weight decay, sequence length, and embedding dimension, among others. These settings can determine how quickly a model learns, its capacity to generalize from training data to unseen data, and its overall complexity. Correctly setting hyperparameters is important because inappropriate values can lead to models that underfit or overfit the data. Underfitting occurs when a model is too simple to learn the underlying pattern of the data, and overfitting happens when a model is too complex, learning the noise in the training data as if it were signal.

At block 420, the direct generation prompts (for the training and testing data) are input into the NL2SQL model (at block 406) via a training and testing subsystem for training and/or testing. The training and testing subsystem is comprised of a combination of specialized hardware and software to efficiently handle the computational demands required for training, validating, and testing a machine learning model. On the hardware side, high-performance GPUs (Graphics Processing Units) may be used for their ability to perform parallel processing, drastically speeding up the training of complex models, especially deep learning networks. CPUs (Central Processing Units), while generally slower for this task, may also be used for less complex model training or when parallel processing is less critical. TPUs (Tensor Processing Units), designed specifically for tensor calculations, provide another level of optimization for machine learning tasks. On the software side, a variety of frameworks and libraries may be utilized, including TensorFlow, PyTorch, Keras, and scikit-learn. These tools offer comprehensive libraries and functions that facilitate the design, training, validation, and testing of a wide range of machine learning models across different computing platforms, whether local machines, cloud-based systems, or hybrid setups, enabling developers to focus more on model architecture and less on underlying computational details.

Training is the initial phase of developing machine learning models such as the NL2SQL model where the model learns to generate SQL queries (output at block 408) based on the data training data (e.g., training flow 405) provided from the training datasets. During this phase, the model iteratively adjusts its internal model parameters to achieve a preset optimization condition. At blocks 402 and 404, the preset optimization condition can be achieved by minimizing the difference between the model output (e.g., generated SQL queries) and the ground truth labels (e.g., gold SQL queries) in the training data. In some instances, the preset optimization condition can be achieved when the preset fixed number of iterations or epochs (full passes through the training dataset) is reached. In some instances, the preset optimization condition is achieved when the performance on the validation dataset stops improving or starts to degrade. In some instances, the preset optimization condition is achieved when a convergence criterion is met, such as when the change in the model parameters falls below a certain threshold between iterations. This process, known as fitting, is fundamental because it directly influences the accuracy and effectiveness of the model.

In an exemplary training phase performed by the training and testing subsystem, the training subset of data is input into the machine learning algorithms to find a set of model parameters (e.g., weights, coefficients, trees, feature importance, and/or biases) that minimizes or maximizes an objective function (e.g., a loss function, a cost function, a contrastive loss function, a cross-entropy loss function, etc.). To train the machine learning algorithms to achieve accurate predictions, “errors” (e.g., a difference between a predicted label and the ground truth label) need to be minimized. In order to minimize the errors (blocks 402 and 404), the model parameters 407 can be configured to be incrementally updated by minimizing the objective function over the training phase (“optimization”). Various different techniques (e.g., stochastic gradient descent) may be used to perform the optimization. For example, to train machine learning algorithms such as an LLM, optimization can be done using back propagation. The current error is typically propagated backwards to a previous layer, where it is used to modify the weights and bias in such a way that the error is minimized. The weights are modified using the optimization function. Other techniques such as random feedback, Direct Feedback Alignment (DFA), Indirect Feedback Alignment (IFA), Hebbian learning, and the like can also be used to update the model parameters in a manner as to minimize or maximize an objective function. This cycle is repeated until a desired state (e.g., a predetermined minimum value of the objective function) is reached.

Validating is another phase of training where the model is checked for deficiencies in performance and the hyperparameters are optimized based on validation data provided from the training datasets. The validation data helps to evaluate the model's performance, such as accuracy, precision, recall, or F1-score, to gauge how well the model is likely to perform in real-world scenarios. Hyperparameter optimization, on the other hand, involves adjusting the settings that govern the model's learning process (e.g., learning rate, number of layers, size of the layers in neural networks) to find the combination that yields the best performance on the validation data. One optimization technique is grid search, where a set of predefined hyperparameter values are systematically evaluated. The model is trained with each combination of these values, and the combination that produces the best performance on the validation set is chosen. Although thorough, grid search can be computationally expensive and impractical when the hyperparameter space is large. A more efficient alternative optimization technique is random search, which samples hyperparameter combinations from a defined distribution randomly. This approach can in some instances find a good combination of hyperparameter values faster than grid search. Advanced methods like Bayesian optimization, genetic algorithms, and gradient-based optimization may also be used to find optimal hyperparameters more effectively. These techniques model the hyperparameter space and use statistical methods to intelligently explore the space, seeking hyperparameters that yield improvements in model performance.

Once a machine learning model has been trained and validated, it undergoes a final evaluation using the test data provided from the training and testing datasets, which is a separate subset of the data that has not been used during the training or validation phases. This step is important as it provides an unbiased assessment of the model's performance in simulating production operation. The test dataset serves as new, unseen data for the model, mimicking how the model would perform when deployed in actual use. During testing, the model's generated SQL queries (output at block 425) can be compared against the true values (e.g., gold SQL queries) in the test dataset using various performance metrics such as accuracy, precision, recall, and mean squared error, depending on the nature of the problem. Additionally, or alternatively, at blocks 410 and 412, the gold and generated SQL queries are executed on the corresponding database using a SQL engine (execution engine; see below in Production Flow section for detailed description) to obtain execution results. At block 416, the result sets (e.g., testing flow 415) from executing the gold and generated SQL queries are compared using an execution match evaluator to compute accuracy execution match metrics. This process helps to verify the generalizability of the model-its ability to perform well across different data samples and environments-highlighting potential issues like overfitting or underfitting and ensuring that the model is robust and reliable for practical applications. The NL2SQL model is fully validated and tested once the outputs have been reported (e.g., testing performance report) and deemed acceptable by user defined acceptance parameters (block 418). Acceptance parameters may be determined using correlation techniques such as Bland-Altman method and the Spearman's rank correlation coefficients and calculating performance metrics such as the error, accuracy, precision, recall, receiver operating characteristic curve (ROC), etc.

The production flow starts at block 422 where production schemas and natural language utterances (real-world input data) are input into the NL2SQL model via a production subsystem for inference. The production subsystem is comprised of various components for deploying machine learning models such as the NL2SQL model in a production environment. In some instances, the NL2SQL resides as a component of a larger system or service (e.g., use with an agent as described with respect to FIGS. 1-3). In some instances, the NL2SQL model and/or the inferences can be used by downstream applications to provide further information. For example, the inferences can be used to hold a conversation with a user as part of an agent or can be used to provide data analysis to a user via an analytical service such as analytics cloud-based service. Deploying the NL2SQL model includes moving the model(s) from a development environment (e.g., the training and testing subsystem, where it has been trained, validated, and tested), into a production environment where it can make inferences on real-world data (e.g., input data). This step typically starts with the model being saved after training, including its parameters and configuration such as final architecture and hyperparameters. It is then converted, if necessary, into a format that is suitable for deployment, depending on the deployment environment. For instance, a model trained in a developmental computing environment such as Python might be converted into a Java-friendly format for integration into a larger enterprise application. Deployment can be conducted on various platforms, including on-premises servers or cloud environments like OCI, AWS, Azure, Google, etc. (see below discussion of various computer and cloud architectures with respect to FIGS. 10-14).

At block 420, the input data (e.g., production schemas and natural language utterances) are populated into the direct generation prompt template (as described above) to create direct generation prompts from which the NL2SQL model generates SQL queries. At block 406, the direct generation prompt is input into the NL2SQL model via the production subsystem for inference. The NL2SQL model then translates the natural language utterance into a SQL query. This translation process includes the NL2SQL model first parsing the natural language utterance to understand the user's intent. This involves identifying the key components of the request, such as the desired action (e.g., SELECT, UPDATE), the entities involved (e.g., tables, columns), and any conditions or filters. For example, if the user says, “Show me all the customers who signed up in the last month,” the model identifies the action (retrieve data), the entities (customers), and the condition (signed up in the last month). The NL2SQL model then maps the identified entities and conditions to the corresponding elements in the schema (e.g., database schema). This step requires knowledge of the database structure, including table names, column names, and data types (which is included within the direct generation prompt template). Continuing with the example, the model needs to know that “customers” refers to a specific table, and “signed up” corresponds to a column (e.g., ‘signup_date’) in that table. Using the parsed intent and mapped schema elements, the NL2SQL model constructs a syntactically correct SQL query. This involves selecting the appropriate SQL keywords and structuring the query according to SQL syntax rules. For the example request, the LLM would generate the following SQL query:

```
  “sql
  SELECT * FROM customers WHERE signup_date >= DATE_SUB(CURDATE( ),
INTERVAL 1 MONTH);
“
```

The NL2SQL model may then validate the constructed SQL query to ensure it aligns with the user's intent and adheres to the database schema. This could involve checking for syntax errors, ensuring the correct use of SQL functions, and verifying the query against the schema. If necessary, the NL2SQL model refines the query to better match the user's request or correct any identified issues. This step might also involve asking the user for clarification if the original utterance was ambiguous. Once generated and optionally validated, the NL2SQL model outputs the SQL queries at block 425.

At blocks 410 and 412, the SQL queries are executed on the corresponding database using a SQL engine (execution engine) to obtain execution results. The execution engine executes the SQL queries on a database by following a multi-step process that involves parsing, optimizing, and executing the query. Initially, an SQL query is parsed to create an internal representation, typically an Abstract Syntax Tree (AST), which outlines the structure of the query. The engine then consults the database schema to validate the query, ensuring that all referenced tables, columns, and data types exist and are correctly used. Once validated, the query undergoes optimization, where the execution engine determines the most efficient way to access and manipulate the data, often through the use of query optimization techniques such as indexing, join algorithms, and query rewriting. This step aims to minimize resource usage and execution time. Finally, the optimized query is executed against the database. The execution engine processes the query plan, retrieves the required data from the storage engine, and applies any necessary transformations, such as filtering, sorting, or aggregating. The resulting data is then formatted and returned to the user (or user(s)) by way of production flow 417 or application that issued the query (block 414), completing the process of data retrieval.

To manage and maintain its performance, a deployed model such as the NL2SQL model may be continuously monitored to ensure it performs as expected over time. This involves tracking the model's inference accuracy, response times, and other operational metrics. Additionally, the model may require retraining or updates based on new data or changing conditions in the environment it is applied in. This can be useful because machine learning models can drift over time due to changes in the underlying data the models are making predictions on-a phenomenon known as model drift. Therefore, maintaining a machine learning model in a production environment often involves setting up mechanisms for performance monitoring, regular evaluations against new test data, and potentially periodic updates and retraining of the model to ensure it remains effective and accurate in making predictions.

### Customizable Distillation Framework

As discussed above, a NL2SQL system is powered by a deep learning model (e.g., an NL2SQL model such as an LLM) configured to convert a natural language (NL) utterance (e.g., a query posed by a user using a digital assistant or chatbot) into a structured query language (SQL) query. Users (e.g., customers) of an NL2SQL service may want the NL2SQL system to generate SQL queries based on requirements and expectations for user use cases. To provide customized query generation, an NL2SQL model can be trained with NL2SQL distillation data. The NL2SQL distillation data is generated using a customizable distillation framework that utilizes one or more large LLMs to synthesize distillation training examples that include synthetic NL questions and corresponding synthetic SQL completions. The distillation data is used to fine-tune a small LLM that can be deployed within the NL2SQL system and can generate SQL queries in a customized manner with respect to user use cases while maintaining accuracy expectations.

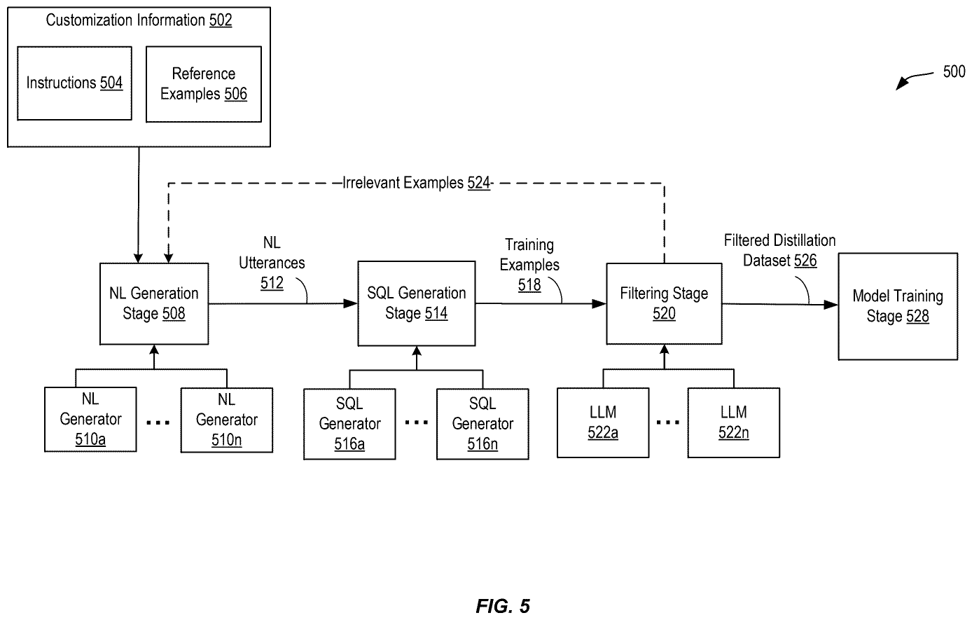

FIG. 5 is a simplified block diagram illustrating aspects of a customizable distillation system 500 for synthesizing distillation data to train an NL2SQL model. The customizable distillation system 500 can be implemented using software only, hardware only, firmware only, or any combination of hardware, software, and/or firmware. The data synthesis process of the customizable distillation system 500 can be used to generate a distillation dataset and train an NL2SQL model included as part of an NL2SQL agent system or NL2SQL tool (e.g., NL2SQL tool 104 from FIG. 1, NL2SQL model 222 from FIG. 2). As depicted in FIG. 5, the customizable distillation system 500 can include a natural language (NL) generation stage 508 that is configured to generate synthetic NL utterances, a SQL generation stage 514 that is configured to generate synthetic SQL completions based on the synthetic NL utterances, and a model training stage 528 that is configured to train a machine learning model using a generated distillation dataset. In some implementations, the customizable distillation system 500 includes a filtering stage 520 that is configured to filter irrelevant and/or incorrect training examples from the generated distillation dataset. Each stage should be understood to be an execution of one or more processes and/or programs implemented with software, hardware, and/or firmware within a system (e.g., as described with respect to FIGS. 10-14).

Customization information 502 is provided to NL generation stage 508. Customization information 502 includes information about user requirements and expectations related to SQL query generation (e.g., preferences on types of commands, queries for financial analytics, complex multiple table-joining, partitions, etc.) in the form of instructions 504 and reference examples 506 (see Table 2 for exemplary instructions and reference examples). Customization information 502 may be generated and provided based on known user preferences or patterns identified in example natural language utterances and/or SQL queries. In some examples, customization information 502 is provided by a user (e.g., a customer). The user may provide examples of natural language utterances and/or SQL queries the customizable distillation system 500 and/or an NL2SQL service is expected to handle. Instructions 504 condense user requirements regarding SQL generation such as, for example, use cases for GROUP BY aggregations, date-time handling in SQL queries, commands that should not be included in a SQL query, etc. As a particular example, a user may want to generate SQL queries that use relative dates and time intervals instead of hardcoded values. Accordingly, instructions 504 may include specific rules for handling relative intervals with days, months, quarters, and the like, as detailed in Table 2. Instructions 504 may be generated based on information (e.g., database information, user SQL query preferences, etc.) provided by a user.

Reference examples 506 can be used as bootstrapping to guide generators towards producing natural language query examples that are relevant to user use cases. In some instances, reference examples 506 can be a list of less than 25, 50, 100, 200, or 500 natural language utterances (e.g., statements or questions). Preferably the reference examples 506 are a list of less than 100 natural language utterances. Reference examples 506 can include natural language utterances shared by a user related to user use cases for aspects of a database schema. As an example, “What project has the largest indirect cost since last January?” can be a reference example included in the set of reference examples 506. An LLM may be provided with a prompt including the reference example and asked to generate a natural language utterance similar to the reference example.

TABLE 2

| Customization | |
|---|---|
| Information | |
| Component | Example |
| Instructions | Refer to the following instructions when |
| | generating the SQL: |
| | - ‘this quarter’: |
| | TRUNC(DATE_column, ‘Q’) = TRUNC |
| | (SYSDATE, ‘Q’) |
| | - ‘last quarter’: |
| | TRUNC(DATE_column, ‘Q’) = |
| | ADD_MONTHS(TRUNC(SYSDATE, ‘Q’), −3) |
| | - ‘last year’: |
| | TO_CHAR(DATE_column, ‘YYYY’) = |
| | TO_CHAR(ADD_MONTHS(SYSDATE, −12), |
| | ‘YYYY’) |
| | - ‘in the last X months': |
| | DATE_column BETWEEN |
| | ADD_MONTHS(SYSDATE, −X) AND |
| | SYSDATE |
| | . . . |
| Reference | Show margin by project vertical in the last |
| Examples | quarter of last year. |
| | Which project has had the largest indirect costs |
| | since last January? |
| | Show all orders of food products which had an |
| | order date of last Tuesday & Thursday |
| | . . . |

The NL generation stage 508 can make use of one or more LLMs (e.g., NL generators 510a-n) configured to generate NL utterances 512. In some instances, NL utterances 512 can be referred to as NL queries or NL questions. The NL generation stage 508 may access a dataset of database schemas to select a target database schema. Each NL generator from NL generators 510a-n generates a large number of synthetic NL questions corresponding to the target database schema. Synthetic NL utterances 512 are generated using the reference examples 504 as inspiration within a prompt provided to NL generators 510a-n. As an example, an original question provided to the LLMs can be: “Show the total tonnage of all cargoes loaded or unloaded at the port of Singapore in 2022.” Each NL generator may augment the original question to produce new questions related to the original question but using different semantic language or vocabulary. As an example, a synthetic NL question generated based on the original question can be: “What is the total tonnage of all cargoes loaded or unloaded at the port of Singapore before last April?” Each NL utterance of the NL utterances 512 is associated with the selected target database schema to create a NL utterance and database schema pair.

The set of NL utterances 512 generated by NL generators 510a-n and instructions 504 are provided to a SQL generation stage 514. One or more LLMs (e.g., SQL generators 516a-n) are used to generate SQL completions for the NL utterances 512. A SQL completion can be or can include a SQL query that corresponds to the generated NL utterance. In some implementations, SQL generator 516a-n generate a description of a SQL query and the description (e.g., chain of thought reasoning, self-explanation) may be included in the SQL completion. As an example, the description may include a reason for why certain syntax was used in the generated SQL query. Below is an example of a generated SQL completion including a SQL query and a description based on the question “What is the total tonnage of all cargoes loaded or unloaded at the port of Singapore before last April?”

```
Here is the SQL query that answers the question:
‘‘‘
SELECT SUM(c.tonnage) FROM cargoes c JOIN ports p ON c.port_id = p.id WHERE
p.name = ‘Singapore’ AND (EXTRACT (YEAR FROM c.load_date) <
EXTRACT(YEAR FROM SYSDATE) − 1 OR (EXTRACT (YEAR FROM c.load_date)
< EXTRACT(YEAR FROM SYSDATE) − 1 AND EXTRACT (MONTH FROM
c.load_date) < 4));
‘‘‘
Here's the explanation:
* We join the ‘cargoes‘ table with the ‘ports‘ table on the ‘port_id‘ column to filter only
cargoes loaded or unloaded at the port of Singapore.
* We use the ‘before/prior to last April‘ condition, which is translated to Oracle SQL as:
  + ‘EXTRACT (YEAR FROM c.load_date) < EXTRACT (YEAR FROM
SYSDATE) − 1‘ (before last year)
  + ‘OR (EXTRACT (YEAR FROM c.load_date) = EXTRACT(YEAR FROM
SYSDATE) − 1 AND EXTRACT(MONTH FROM c.load_date) < 4)‘ (last year, but
before April)
* Finally, we sum up the ‘tonnage‘ column to get the total tonnage of all cargoes loaded
or unloaded at the port of Singapore before last April.
```

The choice of LLMs for the NL generation stage 508 and the SQL generation stage 514 may depend on licenses and constraints. For example, data generated from LLaMA family models may only be capable of fine-tuning models of the same family. In some implementations, NL generators 510a-n may be the same LLMs as SQL generator 516a-n. Using the same LLMs for the NL generation stage 508 and SQL generation stage 514, however, may reduce the strength and diversity of synthetic NL utterance and SQL completion pairs. As an example, a first LLM may excel at generating NL questions, but may perform poorly when generating SQL queries. Conversely, a second LLM may perform poorly when generating NL questions but may excel and generating SQL queries. For such instances, utilizing the first LLM as NL generator 510a and the second LLM as SQL generator 516a may produce training examples 512 with strong NL and SQL examples that can improve accuracy of a trained NL2SQL model.

Training examples 518 are generated based on the generated NL utterances 512 and SQL completions. In some implementations, a training example may be generated by associating a prompt including an NL utterance with a SQL completion and storing the association in a data store, table and/or matrix. In some implementations, a training example may be generated by labelling a prompt including an NL question as an input and labelling a corresponding SQL completion as an output to create an input-output pair. Each training example contains a database schema, synthetic NL utterance, and a corresponding SQL completion. The set of training examples 518 may be used for training a model as described in the training schemas and NL question versus vs) gold SQL query pairs block 424 from FIG. 4. However, the set of training examples 518 may contain noise related to errors from the NL generation stage 508 and/or SQL generation stage 514. As such, the set of training examples 518 may be referred to as a raw synthetic supervised fine-tuning (SFT) dataset and/or a raw distillation dataset.

In some implementations, the customizable distillation system 500 can include a filtering stage 520 to generate a filtered distillation dataset 526 that can be used for model training 528. In some instances, the NL generation stage 508 and/or SQL generation stage 514 may produce training examples 512 that are incorrect or irrelevant. The filtering stage 520 can filter the set of generated training examples 518 to remove examples that are not consistent with the customization information 502 and/or SQL syntax. The filtering stage 520 can include various type of filtering including, but not limited to, pattern-based filtering, execution-based filtering, and quality-based filtering. Pattern-based filtering can be performed to minimize the number of syntax errors or constructs that are non-compliant with a database schema (e.g., Oracle DB) in SQL completions included in each training example. Execution-based filtering can be performed to ensure SQL completions are well formed and include SQL queries that can be executed against a real database interface. SQL completions from the training examples 518 may be executed on a test database and/or in a sandboxed environment to determine whether an error message is produced by the execution attempt. SQL queries that produce an error message can be removed from the set of training examples 518.

Quality-based filtering can be performed using a soft evaluation on the training examples 518 to remove any low quality and/or irrelevant examples. Quality-based filtering can include determining the correctness and relevance of the synthetic NL utterances and SQL completions in each training example. One or more LLMs (e.g., LLMs 522a-n) can be used as judges to rank and prune the generated dataset of training examples 518. The LLMs may be prompted to judge the quality of the generated examples based on one or more criteria including, but not limited to, SQL correctness and NL query relevance. A subset of the training examples 518 may be identified as irrelevant examples 524 by LLMs 522a-n. Irrelevant examples 524 can include NL utterances that are not relevant to user use cases or are not directed to objects included in the associated database schema. Irrelevant examples 524 are not included in the filtered dataset 526 used for model training 528. The irrelevant examples 524 may be provided to the NL generation stage 508 as examples of types of NL utterances that should not be generated by NL generators 510a-n. An initial iteration of the data synthesis process may not include irrelevant examples 524 in the NL generation stage 508, but subsequent iterations of the data synthesis process may include irrelevant examples 524 removed by filtering stage 520 in a previous iteration. As an example, an initial model trained using the filtered dataset 526 may not produce a desired accuracy for a financial analytics customer use case. The data synthesis process may be performed again using irrelevant examples 524 generated during the initial run of the process to generate a new filtered dataset 526 to improve model accuracy for the customer use case.

After being processed by filtering stage 520, the filtered dataset 526 is provided for model training 528. The model being trained may be smaller (i.e., have a smaller number of parameters) than the LLMs used by the NL generation stage 508, SQL generation stage 514, and filtering stage 520. The model training 528 may include a training process described in FIG. 4. In some examples, the model training stage 528 may be or may include a fine-tuning process. Fine-tuning can include adjusting the parameters of a pre-trained model by performing additional training using training examples (e.g., filtered dataset 526) for a specific task or domain such as customized SQL generation.

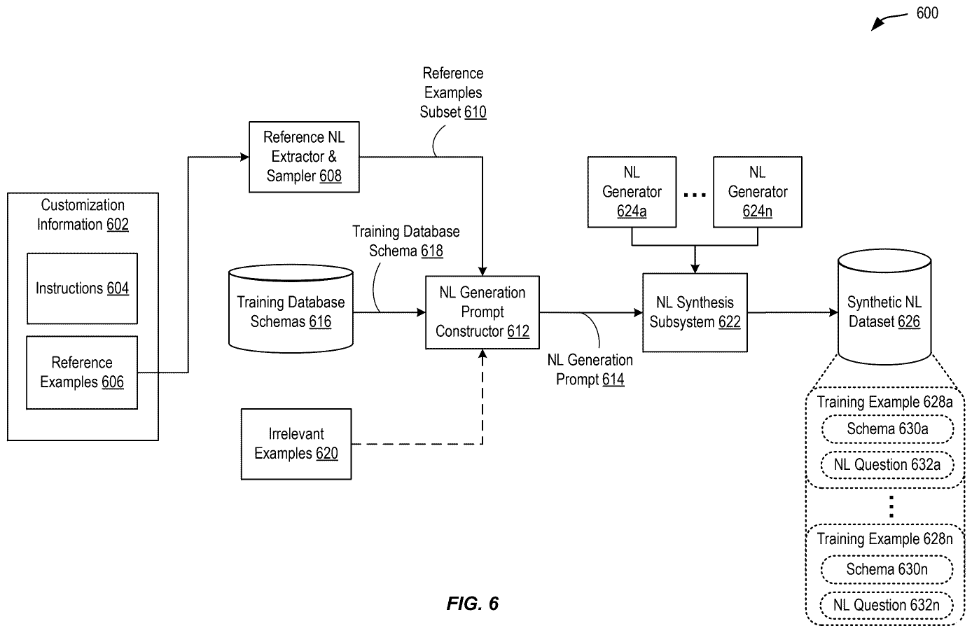

FIG. 6 depicts a simplified block diagram illustrating aspects of a synthetic natural language (NL) generation subsystem 600. The synthetic NL generation subsystem 600 can be a subsystem of the customization distillation system 500 and may be used to implement a NL generation stage 508 as described in FIG. 5 using software only, hardware only, firmware only, or any combination of hardware, software, and/or firmware. The synthetic NL generation subsystem 600 can access customization information 602 (e.g., customization information 502) to generate new synthetic language utterances. As described in FIG. 5, customization information 602 includes instructions 604 (e.g., instructions 504) and reference examples 606 (e.g., reference examples 506).

A reference NL extractor and sampler 608 extracts a subset of NL queries from the reference examples 606. The reference examples subset 610 can be a random sample of M reference examples, where M may be a predetermined value and a hyperparameter of the data synthesis task. In some implementations, M is set to 5 to create a well-inspired and diversified synthetic NL question set, with limited impact on context lengths. A value of M closer to the cardinality of the set of reference examples 606 may produce less diversified generated NL examples due to increased overlapping of question types within NL generation prompts. M may be constrained by the maximum context widow, or the maximum input length in number of tokens, of the generator LLMs (e.g., NL generators 624a-n).

The reference examples subset 610 is provided to a NL generation prompt constructor 612. The NL generation prompt constructor 612 generates a NL generation prompt 614 used to generate new NL questions by a NL synthesis subsystem 622. A training database schema 618 is selected from a set of training database schemas 616. The training database schema 618 may be selected randomly (e.g., with uniform distribution) to generate diverse pairs of NL utterances and database schemas. The training database schema 618 describes the structure of a database, including the tables, the fields within those tables, the relationships between the tables, and any constraints or rules governing the data. Each table in the database represents a collection of related data. Columns represent the attributes or properties of the data stored in the table. Each column has a name and a data type (e.g., integer, varchar, date). In some examples, the set of training database schemas 616 includes database schema(s) provided by a user.

In some implementations, irrelevant examples 620 extracted during filtering as described in FIG. 5 (e.g., filtering stage 520) are provided to the NL generation prompt constructor 612 to iteratively refine the data synthesis task. The irrelevant examples 620 may be previously generated NL queries associated with the training database schema 618 that have been determined to be irrelevant to a user use case during the filtering process. An initial iteration of the NL generation process may not utilize irrelevant examples 620. The number of irrelevant examples 612 may be less than or equal to M.

To generate the NL generation prompt 614, the prompt constructor 612 may access a prompt template and populate the prompt template with the reference examples subset 610, irrelevant examples 620 (in instances where irrelevant examples 620 have been identified), and the target database schema 618. In some examples, populating the prompt template can include a slot filling process. The NL generation prompt 614 instructs each generator LLM to take inspiration from the reference examples subset 610 and generate N new NL examples that are relevant to the target training database schema 618. An example prompt where N equals 5 may look as follows:

NL Generation Prompt Example:

```
Given an Input Schema used in a NL2SQL system, your task is to generation 5 new
Natural Language queries inspired on the Reference Examples below and appropriate to
the Input Schema
- The Reference Examples refer to a particular User use-case, which is the target for the
data generation
- The new examples should have similar or higher level of complexity of the Reference
Examples provided below.
- While taking inspiration on the Reference Examples, you should also be creative in
generating original queries.
- In addition to the Reference Example, please refer to Irrelevant Examples (if any) for
examples of NL queries that are not relevant to the User use-case
## Reference Examples
- show the distance of the flights that arrived before last May
- visits made past more than twelve days
- show a list containing staff names and their respective genders who were assigned 2
days ago
- Find the names of the university which has more faculties in 2002 than every university
in Orange county.
- What is all the information about employees hired until June 21, 2002?
## Irrelevant Examples
- show oldest ship in the port of Singapore
## Input Schema
‘‘‘
CREATE TABLE ports(
  id INT,
  name VARCHAR(255),
  country VARCHAR(255)
)
CREATE TABLE cargoes(
  id INT,
  name VARCHAR(255),
  tonnage INT,
  port_id INT,
  load_date DATE
)
## Generated Examples
```

The NL generation prompt 614 is provided as an input to the NL synthesis subsystem 622. The NL synthesis subsystem 622 may use multiple LLMs (e.g., NL generators 624a-n) to generate synthetic NL questions. To increase output cardinality, each LLM may be run multiple times with different random seeds and high temperature values. A run may be defined as providing the NL generation prompt 614 to the LLM and receiving an output comprising synthetic NL questions. As a particular example, using two LLMs, setting N=10, and performing five runs per LLM may generate around 100 new NL questions from a single NL generation prompt 618. In some implementations, large LLMs with over 50 billion parameters may be used for the NL synthesis subsystem 622, as they may show better understandings of generation instructions in the prompt and produce more diversity in the generated results.

NL synthesis subsystem 622 may be iteratively executed by constructing a new NL generation prompt 614 and performing the generation process until a desired number of NL questions have been generated. Each iteration of the NL generation process may use a different target training database schema 618 in the NL generation prompt 614 to ensure a diverse selection of schema and NL question pairs. Each generated NL question is associated with the target schema 618 included in the NL generation prompt 614 used to generate the question.

The result of executing the NL synthesis subsystem 622 is a synthetic NL dataset 626 containing a set of new natural language queries relevant to a user use case and mapped to a database schema. The synthetic NL dataset 626 includes training examples 628a-n. Each training example 628a includes an NL question 632a and a schema 630a corresponding to the training database schema 618 included in the NL generation prompt 614. Schema 628a and schema 628b may be the same or different for each training example. Each NL question may be generated by a different NL generator. For example, NL question 632a may be generated by NL generator 624a and NL question 632b may be generated by NL generator 624b.

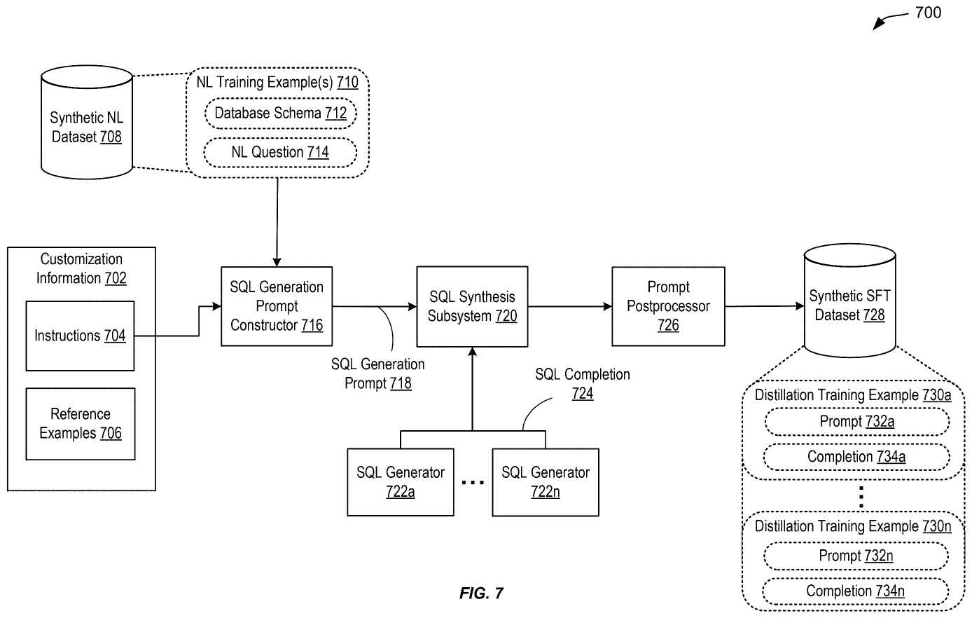

FIG. 7 is a simplified block diagram illustrating aspects of a SQL generation subsystem 700 for generating training examples containing synthetic SQL completions for a SQL generation stage (e.g., SQL generation stage 514 of FIG. 5) of a customizable distillation framework. Given a set of examples with a new question and DB schema, the SQL generation system 700 may use a pool of generator LLMs to translate generated NL utterances into their SQL representation. SQL generation produces a raw distillation data set, where each distillation training example within the distillation dataset is a complete NL2SQL training data point including at least an NL utterance, database schema, and SQL completion. SQL generation may use multiple large LLMs as generators. This may be beneficial to scale-up results to obtain more data, increases data diversity, and mitigate specific gaps for a particular LLM. SQL generation is also conditioned on a set of curated instructions 704 (e.g., instructions 504 from FIG. 5), which customize the generation process to align generated SQL queries to data requirements from user expectations reflected in customization information 702.

A synthetic NL dataset 708 containing NL training example(s) 710 may be generated as described in FIG. 6 (e.g., synthetic NL dataset 628). Each NL training example 710 includes a database schema 712 and NL question 714 pair. An NL training example 710 and instructions 704 are provided to a SQL generation prompt constructor 716. The SQL generation prompt constructor 812 generates a SQL generation prompt 718 containing a set of instructions, a natural language question, and database schema. The SQL generation prompt constructor 812 may access a prompt template and populate relevant sections (e.g., slot filling) of the prompt template with the instructions 704, database schema 712, and NL question 714, respectively. As an example, the goal of a particular data synthesis task may be to improve model weakness on “group-by” aggregations. Accordingly, the instructions 704 can include rules related to aggregators (e.g., COUNT, SUM, AVG, MIN, MAX) within SQL queries and guidance for using aggregators that may improve model performance.

As another example, for a date-time use case, the instructions 704 can include specific rules for SQL generators 722a-n to follow for handling relative intervals such as days, months and quarters. Below is an example of a SQL generation prompt 718 construction for a date-time use case.

SQL Generation Prompt:

```
Here is the database schema context:
CREATE TABLE ports(
  id INT,
  name VARCHAR(255),
  country VARCHAR(255)
)
CREATE TABLE cargoes(
  id INT,
  name VARCHAR(255),
  tonnage INT,
  port_id INT,
  load_date DATE
)
Instructions:
- With a DATE_column, refer to the following instructions:
- ‘today’: TRUNC(DATE_column) = TRUNC(SYSDATE)
- ‘yesterday’: TRUNC(DATE_column) = TRUNC(SYSDATE)−1
- ‘tomorrow’: TRUNC(DATE_column) = TRUNC(SYSDATE)+1
...
- ‘until this November’: TRUNC(DATE_column, ‘MM’) <=
ADD_MONTHS(TRUNC(SYSDATE, ‘YYYY’), 12-1) # beginning of this year + 10
months to align with start of November (EXTRACT(MONTH not needed here)
- ‘from last May/since last May/starting from last May’: TRUNC(DATE_column, ‘MM’)
>= ADD_MONTHS(TRUNC(SYSDATE − INTERVAL ‘1’ YEAR, ‘YYYY’) , 5-1) #
beginning of last year + 4 months to align with start of May (EXTRACT(MONTH not
needed here)
- ‘since last July/from last July/starting from last July’: TRUNC(DATE_column, ‘MM’)
>= ADD_MONTHS(TRUNC(SYSDATE − INTERVAL ‘1’ YEAR, ‘YYYY’) , 7-1) #
beginning of last year + 6 months to align with start of July (EXTRACT(MONTH not
needed here)
- ‘until last September’: TRUNC(DATE_column, ‘MM’) <=
ADD_MONTHS(TRUNC(SYSDATE − INTERVAL ‘1’ YEAR, ‘YYYY’) , 9-1) # −
INTERVAL ‘1’ YEAR to point to the beginning of last year + 8 months to align with start
of September (EXTRACT(MONTH not needed here)
- ‘until last May’: TRUNC(DATE_column, ‘MM’) <=
ADD_MONTHS(TRUNC(SYSDATE − INTERVAL ‘1’ YEAR, ‘YYYY’) , 5-1) # −
INTERVAL ‘1’ YEAR to point to the beginning of last year + 4 months to align with start
of May (EXTRACT(MONTH not needed here)
- ‘before/prior to last February’: TRUNC(DATE_column, ‘MM’) <
ADD_MONTHS(TRUNC(SYSDATE − INTERVAL ‘I’ YEAR, ‘YYYY’) , 2-1) #
INTERVAL ‘1’ YEAR to point to the beginning of last year + 1 months to align with start
of Feb (EXTRACT(MONTH not needed here)
- ‘until next November’: TRUNC(DATE_column, ‘MM’) <=
ADD_MONTHS(TRUNC(SYSDATE + INTERVAL ‘1’ YEAR, ‘YYYY’) , 11-1) # +
INTERVAL ‘1’ YEAR to point to the beginning of last year + 10 months to align with
start of November (EXTRACT(MONTH not needed here)
- ‘from next October’: TRUNC(DATE_column, ‘MM’) >=
ADD_MONTHS(TRUNC(SYSDATE + INTERVAL ‘1’ YEAR, ‘YYYY’) , 10-1) # +
INTERVAL ‘1’ YEAR to point to the beginning of next year + 9 months to align with
start of November (EXTRACT(MONTH not needed here)
Question: What's the total tonnage of all cargoes loaded or unloaded at the port of
Singapore before last April
Write a SQL query in Oracle SQL dialect, compatible with the latest version of Oracle
Database, that answers the question above.
```

The SQL generation prompt 718 is provided to a SQL synthesis subsystem 720. The SQL synthesis subsystem 720 may use one or more SQL generators (e.g., SQL generators 722a-n). Each SQL generator can be a large LLM, and each SQL generator may be a different LLM. Based on the SQL generation prompt 718, each SQL generator produces a SQL completion 724 for the NL question 714. The SQL completion 724 may be referred to as a SQL response and can include a SQL query. In some implementations, the SQL completion 724 includes a description of the SQL query. Keeping short descriptions may improve the learning of a small model by breaking down and simplifying new SQL knowledge. For example, a SQL description can explain how a final complex data-time clause is composed. The SQL completion 724 may be considered the gold query (i.e., ground truth) used during training to determine model accuracy and calculate training loss as described in FIG. 4. Below is an example of a SQL completion that may be generated during SQL generation:

SELECT SUM(c.tonnage) FROM cargoes c JOIN ports p ON c.port_id = p.id WHERE
p.name = ′Singapore′ AND (EXTRACT(YEAR FROM c.load_date) <
EXTRACT(YEAR FROM SYSDATE) − 1 OR (EXTRACT(YEAR FROM c.load_date)
EXTRACT(YEAR FROM SYSDATE) − 1 AND EXTRACT(MONTH FROM
c.load_date) < 4));
‘‘‘

We use the ‘before/prior to last April’ condition, which is translated to Oracle SQL as:

+ ‘EXTRACT(YEAR FROM c.load_date) < EXTRACT(YEAR FROM
SYSDATE) − 1‘ (before last year)
+ ‘OR (EXTRACT(YEAR FROM c.load_date) = EXTRACT(YEAR FROM
SYSDATE) − 1 AND EXTRACT(MONTH FROM c.load_date) < 4)‘ (last year,
but before April)

A prompt postprocessor 726 derives the final prompt (e.g., prompts 732a-n) included in each distillation training example (e.g., distillation training examples 730a-n) within a synthetic supervised fine-tuning (SFT) dataset 728. The final prompt may contain the same components as the SQL generation prompt 718, but with instructions 704 removed from the prompt. Including instructions 704 in the final prompt can confuse a small model at training time and may be excessive since the knowledge is distilled in the form of the generated training data that teach correct SQL behaviors. A prompt 732a may contain the database schema 712, NL question 714, and a target output question. The prompt 732a is paired with a corresponding completion 734a (e.g., the generated SQL completion 724) and added to the synthetic SFT dataset 728 as a new distillation training example 730a.

In some instances, multiple distillation training examples in the synthetic SFT dataset 728 can include the same prompt but different completions. For example, prompt 732a and prompt 732b may be the same prompt, but completion 734a may be generated by SQL generator 722a and completion 734b may be generated by SQL generator 722b. In some implementations, both distillations training examples may be included in the final dataset used for model training. In other implementations, a filtering process may remove one or more of the examples by determining the quality of the SQL completion.

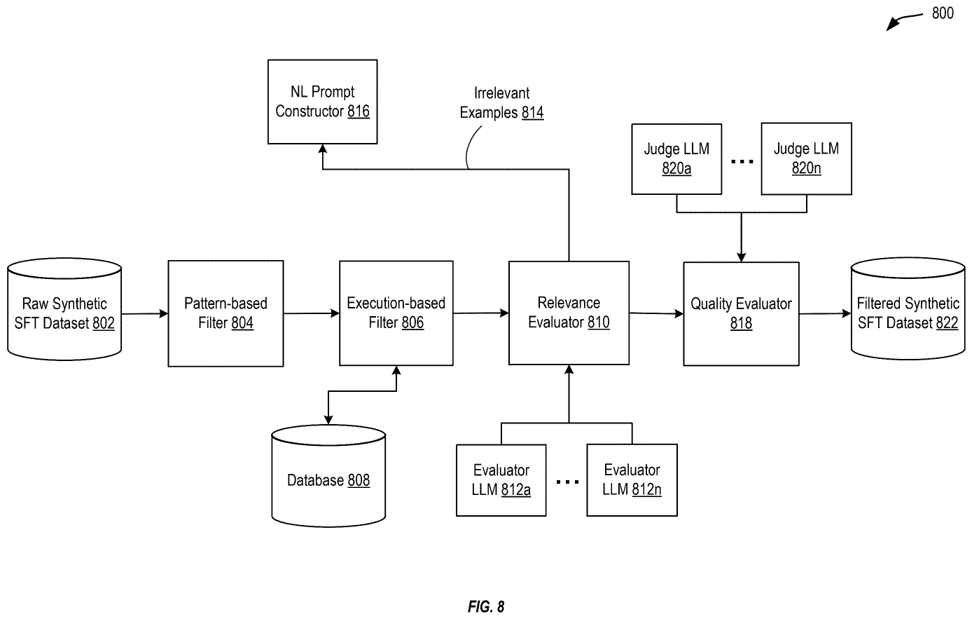

FIG. 8 is simplified block diagram depicting aspects of a filtering subsystem 800 for filtering synthetic supervised fine-tuning (SFT) data generated by a customizable distillation system. The filtering subsystem 800 can be a subsystem of the customization distillation system 500 and may be used to implement a filtering stage 520 as described in FIG. 5 using software only, hardware only, firmware only, or any combination of hardware, software, and/or firmware. Filtering is performed on a raw synthetic supervised finetuning (SFT) dataset 802 (e.g., training examples 518, synthetic SFT dataset 728) generated by SQL generation as described in FIG. 7. The raw synthetic SFT dataset 802 may contain noise due to one or more models from the NL generation and/or SQL generation stages misinterpreting instructions or producing mistakes in generated NL or SQL queries. To prevent errors or noise from appearing in the final training dataset, a filtering process as depicted in FIG. 8 may be used to remove any examples containing errors. The filtering system 800 can be implemented for a filtering stage 520 as described in FIG. 5.

A pattern-based filter 804 is applied to the raw synthetic SFT dataset 802 to remove examples where the SQL completion contains incorrect syntax or statements. As a particular example, database schema information associated with the training example may indicate that SQL queries should follow Oracle syntax, but the pattern-based filter 804 may identify SQL queries containing mySQL keywords and remove those queries from the dataset. In some implementations, the pattern-based filter 804 accesses a collection of common keywords relating to syntax errors or noncompliant constructs. If any keywords from the collection are identified within a SQL completion by the pattern-based filter 804, the associated training example may be removed from the raw synthetic SFT dataset 802.

After applying the pattern-based filter 804, the synthetic SFT dataset execution-based filtering. The execution-based filter 806 checks the validity of the SQL in SFT data examples by executing it against a database. The database 808 can be a database object associated with the schema context in the prompt within the training example in the raw synthetic SFT dataset 802. By using execution-based filters, a model may not be trained with any non-executable and incorrect SQL queries. The execution-based filter 806 executes the SQL completion within the training example against the database 808. The database 808 may be in a sandboxed environment and may not contain any real user or production data. If the SQL completion contains any errors, an error message can be produced from the database 808 query execution. In such examples, the training example containing the nonexecutable SQL completion is removed from the raw synthetic SFT dataset 802. As a particular example, the database 808 may contain tables named “ports” and “cargoes.” The SQL completion within the training example may contain a query for a table named “ships.” The SQL completion may not contain any syntax errors and may pass the pattern-based filter 804. However, executing the SQL completion on the database 808 produces an error because the database 808 does not contain any object named “ships.” In such an example, the training example containing the SQL completion is removed from the synthetic SFT data 802.

In some implementations, each filtering stage may be performed in a different order. For example, the execution-based filter 806 may be applied before the pattern-based filter 804. Performing the filtering in the order depicted in FIG. 8, however, may reduce the training load on the filtering system 800. As an example, applying the pattern-based filter 804 first can reduce the number of training examples that will be executed by the execution-based filter 806.

A relevance evaluator 810 may be used to determine the relevance of generated data, which may be technically correct but irrelevant to the target and user use case expressed by the list of reference examples. This may occur if the input schema used in the NL generation phase is not particularly suitable to the generation of relevant NL examples. The relevance evaluator 810 may be or may utilize one or more LLMs (e.g., evaluator LLMs 812a-n) to determine if the generated example is relevant to the use case represented by the reference natural language examples. In implementations where multiple LLMs are used to determine relevance, if all LLMs agree on the example being relevant, the example can be added to the final synthetic instruction fine-tuning set. If all the LLMs agree on the example being irrelevant, the example is added to a set of irrelevant examples 814. In some implementations, if all LLMs do not agree on a relevance, the training example may be removed from the raw synthetic SFT dataset 802, but not added to the set of irrelevant examples 814. As an example, if evaluator LLM 812a and evaluator LLM 812b determine the natural language question is relevant but evaluator LLM 812c determines the natural language question is irrelevant, the training example may not be added to the filtered synthetic SFT dataset 822 or irrelevant examples 814. In other implementations, the determination of the majority of evaluator LLMs 812a-n may be used to determine which set to add the training example to. The irrelevant examples 814 can be sent to an NL prompt constructor 816 (e.g., NL generation prompt constructor 612 of FIG. 6) to be included as irrelevant examples NL generation should avoid when creating new natural language questions.

An example prompt for an LLM to determine the relevance of natural language questions can look as follows:

Given a Natural Language query and the corresponding SQL Query generated for a
NL2SQL Model, your goal is to assess whether the generated example is relevant to the
User use-case represented by any of the Reference Examples shown below.
## Reference Examples

| | |
|---|---|
| - | Show the distances of the flights that arrived before last May |
| - | Visits made past more than twelve days |
| - | Find the names of the university which has more faculties in 2002 than every |
| | university in Orange County. |
| - | What is all the information about employees hired until June 21, 2002? |
| - | Show me the aircraft names that travelled 8430 kms that departed before |
| | November of 4 years ago |
| - | How many students exist who are registered with just a single allergy? |
| - | Show all maintenance contracts that end until next Dec |
| - | Give me the list of actors which was last updated until last Saturday |
| - | Show the distance of the lights that arrived before last January |
| - | Show all machines made in 1992 |
| - | Show me invoices that are due to be paid in the next half year |
| - | What is all the information about employees hired until June 21, 2002? |
| - | Show all order items delivered before last march |
| - | Show the number of attendees in year 2008 or 2010 |
| - | Show me all students who registered for a course from 3 days ago, including the |
| | course name and student details |
| - | Give people addresses who lived on address till april |
| - | list all users who placed an order from the next 30 days and the order status is |
| | ‘New’. |
| - | Show all maintenance contracts that end until next May |
| - | How many users are not responded to mailshot sent from week 5 2018 |

## Input Natural Language query and SQL query
Natural language query: What's the total tonnage of all cargoes loaded or unloaded at the
port of Singapore before last April
SQL Query: SELECT SUM(c.tonnage) FROM cargoes c JOIN port ON c.port_id = p.id
WHERE p.name = ‘Singapore’ AND (EXTRACT (YEAR FROM c.load_date) <
EXTRACT(YEAR FROM SYSDATE) − 1 OR (EXTRACT(YEAR FROM c.load_date)
EXTRACT(YEAR FROM SYSDATE) − 1 AND EXTRACT(MONTH FROM
c.load_date) < 4));
## Assessment (“**Relevant **”/“**Irrelevant**”)

After removing the irrelevant examples 814, the raw synthetic SFT dataset 802 is sent to a quality evaluator 818. The quality evaluator 818 may be or make use of one or more LLMs (e.g., judge LLMs 820a-n). The quality evaluator 818 checks whether the SQL query meaning corresponds to the NL question. The quality evaluator 818 may determine the quality of the NL question, the correctness of the SQL completion, and the quality of the SQL completion in terms of how well it corresponds to the NL question. A panel of LLMs approach may be used to conduct a soft evaluation using multiple strong LLMs as judges. In some implementations, each judge LLM assigns a score between 1 and 5 for each criterion. The cutoff score may be a hyperparameter for the data synthesis task. In some implementations, agreement on a score of 5 is required for SQL correctness and compliance with standards, and a score greater than or equal to 4 for NL quality is required to be added to the filtered synthetic SFT data 822. Training examples that do not produce an average score meeting the score cutoffs are removed from the raw synthetic SFT dataset 802. An example prompt for judge LLMs 820a-n is as follows, though other implementations may use various other prompts to perform quality evaluations:

```
Given an input Question and an Oracle SQL query, prepare an assessment based on the
following criteria:
SQL Correctness
- Add one star if the Oracle SQL query returns incorrect results
- Add one more star, i.e. award 2 stars if the Oracle SQL query executes but returns
partially correct results
- Add one more star, i.e. award 3 stars if the Oracle SQL query returns mostly correct
results but with minor inaccuracies or omissions
- Add one more star, i.e. award 4 stars if the Oracle SQL query returns correct results
with negligible issues
- Add one more star, i.e. award 5 stars if the Oracle SQL query returns accurate and
complete results as per the requirement
Compliance with Oracle SQL Standards
- Add one star if the SQL query does not follow Oracle SQL standards or best practices,
using deprecated or non-standard syntax
- Add one more star, i.e. award 2 stars if the SQL query loosely follows Oracle SQL
standards, with several deviations from best practices.
- Add one more star, i.e. award 3 stars if the SQL query generally follows Oracle SQL
standards but has room for better alignment with best practices.
- Add one more star, i.e. award 4 stars if the SQL query closely follows Oracle SQL
standards and adheres to many best practices.
- Add one more star, i.e. award 5 stars if the SQL query strictly adheres to Oracle SQL
standards and best practices, showcasing exemplary coding standards.
Quality of the Natural Language Query
- Add one star if the natural language query does not match the SQL, or cannot be
answered given the provided Schema.
- Add one more star, i.e. award 2 stars if the natural language query matches the SQL, but
the question does not make any sense to be asked (totally unrealistic).
- Add one more star, i.e. award 3 stars if the natural language query is consistent with the
SQL, but it does not look natural (no domain knowledge, the style looks synthetic-
templated, does not use “domain-specific” words).
- Add one more star, i.e. award 4 stars if the natural language query is correct and
consistent, but the NL Question can further be improved for clarity, conciseness, small
typos.
- Add one more star, i.e. award 5 stars if the natural language query is perfect.
The Schema context is provided below.
CREATE TABLE ports(
  id INT,
  name VARCHAR(255),
  country VARCHAR(255)
)
CREATE TABLE cargoes(
  id INT,
  name VARCHAR(255),
  tonnage INT,
  port_id INT,
  load_date DATE
)
Question: What's the total tonnage of all cargoes loaded or unloaded at the port of
Singapore before last April
Oracle SQL: SELECT SUM(c.tonnage) FROM cargoes c JOIN ports p ON c.port_id =
p.id WHERE p.name = ‘Singapore’ AND (EXTRACT(YEAR FROM c.load_date) <
EXTRACT(YEAR FROM SYSDATE) − 1 OR (EXTRACT(YEAR FROM c.load_date)
EXTRACT(YEAR FROM SYSDATE) − 1 AND EXTRACT(MONTH FROM
c.load_date) < 4));
The output must have following items in an orderly manner:
- The final star ratings of criterions in a list-wise manner
- The final star ratings of criterions in a json format
- Explain the scores with a short text (< 100 words).
```

Following the quality evaluator 818, a filtered synthetic SFT dataset 822 (e.g., filtered distillation dataset 526 of FIG. 5) without irrelevant and incorrect training examples is produced. The filtered synthetic SFT dataset 822 may include all training examples that were not removed from the raw synthetic SFT dataset 802. The filtered synthetic SFT dataset 822 may be used to train a smaller LLM for NL2SQL as described with respect to FIG. 5.

### Illustrative Methods

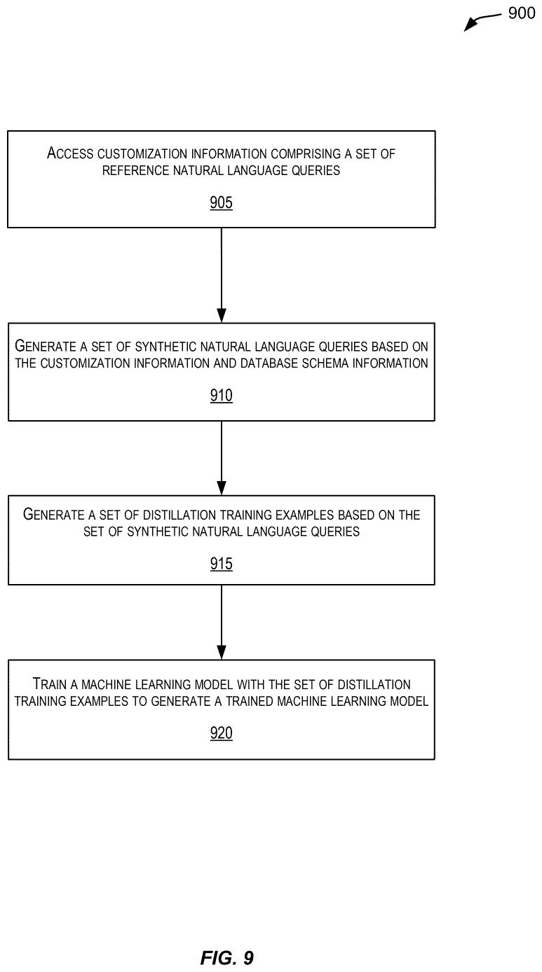

FIG. 9 is a flowchart illustrating a process 900 for generating a set of distillation training examples to train a machine learning model for transforming natural language to programming language, according to various embodiments. The processing depicted in FIG. 9 may be implemented in software (e.g., code, instructions, a program) executed by one or more processing units (e.g., one or more processors, cores) of the respective systems, hardware, or combinations thereof described throughout. The software may be stored on a non-transitory storage medium (e.g., on a memory device). Although the methods presented in FIG. 9 depict the various processing steps occurring in a particular sequence or order, this is not intended to be limiting. In certain alternative embodiments, the steps may be performed in parallel and/or in a different order. In certain embodiments, such as in the embodiments depicted in FIGS. 1-8, the processing depicted in FIG. 9 may be performed by a customizable distillation system 500, as described with respect to FIG. 5, and/or a training, testing, and deployment or production system or subsystem, as described with respect to FIG. 4.

At block 905, customization information (e.g., customization information 502 of FIG. 5) comprising a set of reference natural language queries is accessed. Each reference natural language query of the set of reference natural language queries can be a natural language utterance (e.g., a statement or question). The customization information may further include customer-specific instructions and may be produced based on known user preferences and/or patterns.

At block 910, a set of synthetic natural language queries (e.g., synthetic NL dataset 626 of FIG. 6) is generated by one or more first generative artificial intelligence models based on the customization information and database schema information. Each synthetic natural language query of the set of synthetic natural language queries may be an augmented version of a reference natural language query of the set of reference natural language queries. Each synthetic natural language query can be a synthetic natural language utterance.

Generating the set of synthetic natural language queries can include extracting a subset of reference natural language queries from the set of reference natural language queries, identifying a training database schema based on the database schema information, generating a first prompt comprising the subset of reference natural language queries, a target question, the training database schema, and a natural language query generation instruction, and providing the first prompt as an input to the one or more first generative artificial intelligence models. The training database schema may be retrieved from a set of training database schemas. The first prompt can further include an irrelevant natural language query associated with one or more irrelevant training examples.

At block 915, a set of distillation training examples (e.g., synthetic SFT dataset 728 of FIG. 7) is generated by one or more second artificial intelligence models based on the set of synthetic natural language queries. Generating the set of distillation training examples can include generating a synthetic programming language query for each synthetic natural language query of the set of synthetic natural language queries. Generating the set of distillation training examples can further include generating each distillation training example of the set of distillation training examples such that each distillation training example comprises: (i) a synthetic natural language query, (ii) a database schema from the database schema information associated with the synthetic natural language query, and (iii) a synthetic programming language query corresponding with the synthetic natural language query.

Generating a synthetic programming language query for each synthetic natural language query can further include constructing a second prompt, where the second prompt includes a synthetic natural language query of the set of synthetic natural language queries, a database schema associated with the synthetic natural language query, and a programming language query generation instruction. Generating a synthetic programming query can further include generating the synthetic programming language query associated with the synthetic natural language query based on the second prompt and using the one or more second generative artificial intelligence models; and generating a description of the synthetic programming language query.

Prior to block 920, the process 900 can include filtering the set of distillation raining examples to generate a filtered set of distillation training examples (e.g., filtered synthetic SFT dataset 822 of FIG. 8). Filtering can include performing pattern-based filtering on the set of distillation training examples, where the pattern-based filtering includes removing, from the set of distillation training examples, one or more distillation training examples including a synthetic programming language query with a syntax error. Filtering can further include performing execution-based filtering on the set of distillation raining examples, where the execution-based filtering, for each distillation training example of the set of distillation training examples, includes executing a synthetic programming language query included in the distillation training example on a database, and when executing the synthetic programming language query on the database fails, removing the distillation training examples from the set of distillation training examples. Filtering may further include performing quality evaluation filtering, by one or more third generative artificial intelligence models, on the set of distillation training examples. The quality evaluation filtering comprises performing a quality evaluation on each distillation training example of the set of distillation training examples and removing one or more irrelevant training examples from the distillation dataset.

The quality evaluation can further include determining, by the one or more third generative artificial intelligence models, a correctness score for the synthetic programming language query based on the synthetic natural language query. The quality evaluation may further include determining a relevance of the distillation training example based on the set of reference natural language queries.

At block 920, a machine learning model is trained with the set of distillation training examples to generate a trained machine learning model. The machine learning model may be a generative artificial intelligence model. In some implementations, the trained machine learning model is provided (e.g., deployed) to a natural language to logical form system, where it can be used to execute processes for converting a natural language utterance to logical form (which can be used as part of a larger system such as a digital assistant or chatbot). The processes can include receiving an input from a user, the input comprising a natural language component; converting the input into a prompt, wherein the prompt comprises an instruction, a database schema associated with the natural language component, and an utterance associated with the natural language component; transmitting the prompt to the trained machine learning model; receiving, from the trained machine learning model, a programming language query corresponding to the utterance based at least in part on the prompt; executing the programming language query on a database to obtain a query result; and providing the query result to the user.

As used herein, when an action is “based on” something, this means the action is based at least in part on at least a part of the something.

### Illustrative Systems

The term cloud service is generally used to refer to a service that is made available by a cloud service provider (CSP) to users (e.g., cloud service customers) on demand (e.g., via a subscription model) using systems and infrastructure (cloud infrastructure) provided by the CSP. Typically, the servers and systems that make up the CSP's infrastructure are separate from the user's own on-premise servers and systems. Users can thus avail themselves of cloud services provided by the CSP without having to purchase separate hardware and software resources for the services. Cloud services are designed to provide a subscribing user easy, scalable access to applications and computing resources without the user having to invest in procuring the infrastructure that is used for providing the services.

There are several cloud service providers that offer various types of cloud services. As discussed herein, there are various types or models of cloud services including IaaS, software as a service (SaaS), platform as a service (PaaS), and others. A user can subscribe to one or more cloud services provided by a CSP. The user can be any entity such as an individual, an organization, an enterprise, and the like. When a user subscribes to or registers for a service provided by a CSP, a tenancy or an account is created for that user. The user can then, via this account, access the subscribed-to one or more cloud resources associated with the account.

As noted above, IaaS is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 10 is a block diagram 1000 illustrating an example pattern of an IaaS architecture, according to at least one embodiment. Service operators 1002 can be communicatively coupled to a secure host tenancy 1004 that can include a virtual cloud network (VCN) 1006 and a secure host subnet 1008. In some examples, the service operators 1002 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1006 and/or the Internet.

The VCN 1006 can include a local peering gateway (LPG) 1010 that can be communicatively coupled to a secure shell (SSH) VCN 1012 via an LPG 1010 contained in the SSH VCN 1012. The SSH VCN 1012 can include an SSH subnet 1014, and the SSH VCN 1012 can be communicatively coupled to a control plane VCN 1016 via the LPG 1010 contained in the control plane VCN 1016. Also, the SSH VCN 1012 can be communicatively coupled to a data plane VCN 1018 via an LPG 1010. The control plane VCN 1016 and the data plane VCN 1018 can be contained in a service tenancy 1019 that can be owned and/or operated by the IaaS provider.

The control plane VCN 1016 can include a control plane demilitarized zone (DMZ) tier 1020 that acts as a perimeter network (e.g., portions of a corporate network between the corporate intranet and external networks). The DMZ-based servers may have restricted responsibilities and help keep breaches contained. Additionally, the DMZ tier 1020 can include one or more load balancer (LB) subnet(s) 1022, a control plane app tier 1024 that can include app subnet(s) 1026, a control plane data tier 1028 that can include database (DB) subnet(s) 1030 (e.g., frontend DB subnet(s) and/or backend DB subnet(s)). The LB subnet(s) 1022 contained in the control plane DMZ tier 1020 can be communicatively coupled to the app subnet(s) 1026 contained in the control plane app tier 1024 and an Internet gateway 1034 that can be contained in the control plane VCN 1016, and the app subnet(s) 1026 can be communicatively coupled to the DB subnet(s) 1030 contained in the control plane data tier 1028 and a service gateway 1036 and a network address translation (NAT) gateway 1038. The control plane VCN 1016 can include the service gateway 1036 and the NAT gateway 1038.

The control plane VCN 1016 can include a data plane mirror app tier 1040 that can include app subnet(s) 1026. The app subnet(s) 1026 contained in the data plane mirror app tier 1040 can include a virtual network interface controller (VNIC) 1042 that can execute a compute instance 1044. The compute instance 1044 can communicatively couple the app subnet(s) 1026 of the data plane mirror app tier 1040 to app subnet(s) 1026 that can be contained in a data plane app tier 1046.

The data plane VCN 1018 can include the data plane app tier 1046, a data plane DMZ tier 1048, and a data plane data tier 1050. The data plane DMZ tier 1048 can include LB subnet(s) 1022 that can be communicatively coupled to the app subnet(s) 1026 of the data plane app tier 1046 and the Internet gateway 1034 of the data plane VCN 1018. The app subnet(s) 1026 can be communicatively coupled to the service gateway 1036 of the data plane VCN 1018 and the NAT gateway 1038 of the data plane VCN 1018. The data plane data tier 1050 can also include the DB subnet(s) 1030 that can be communicatively coupled to the app subnet(s) 1026 of the data plane app tier 1046.

The Internet gateway 1034 of the control plane VCN 1016 and of the data plane VCN 1018 can be communicatively coupled to a metadata management service 1052 that can be communicatively coupled to public Internet 1054. Public Internet 1054 can be communicatively coupled to the NAT gateway 1038 of the control plane VCN 1016 and of the data plane VCN 1018. The service gateway 1036 of the control plane VCN 1016 and of the data plane VCN 1018 can be communicatively coupled to cloud services 1056.

In some examples, the service gateway 1036 of the control plane VCN 1016 or of the data plane VCN 1018 can make application programming interface (API) calls to cloud services 1056 without going through public Internet 1054. The API calls to cloud services 1056 from the service gateway 1036 can be one-way: the service gateway 1036 can make API calls to cloud services 1056, and cloud services 1056 can send requested data to the service gateway 1036. But, cloud services 1056 may not initiate API calls to the service gateway 1036.

In some examples, the secure host tenancy 1004 can be directly connected to the service tenancy 1019, which may be otherwise isolated. The secure host subnet 1008 can communicate with the SSH subnet 1014 through an LPG 1010 that may enable two-way communication over an otherwise isolated system. Connecting the secure host subnet 1008 to the SSH subnet 1014 may give the secure host subnet 1008 access to other entities within the service tenancy 1019.

The control plane VCN 1016 may allow users of the service tenancy 1019 to set up or otherwise provision desired resources. Desired resources provisioned in the control plane VCN 1016 may be deployed or otherwise used in the data plane VCN 1018. In some examples, the control plane VCN 1016 can be isolated from the data plane VCN 1018, and the data plane mirror app tier 1040 of the control plane VCN 1016 can communicate with the data plane app tier 1046 of the data plane VCN 1018 via VNICs 1042 that can be contained in the data plane mirror app tier 1040 and the data plane app tier 1046.

In some examples, users of the system, or customers, can make requests, for example create, read, update, or delete (CRUD) operations, through public Internet 1054 that can communicate the requests to the metadata management service 1052. The metadata management service 1052 can communicate the request to the control plane VCN 1016 through the Internet gateway 1034. The request can be received by the LB subnet(s) 1022 contained in the control plane DMZ tier 1020. The LB subnet(s) 1022 may determine that the request is valid, and in response to this determination, the LB subnet(s) 1022 can transmit the request to app subnet(s) 1026 contained in the control plane app tier 1024. If the request is validated and requires a call to public Internet 1054, the call to public Internet 1054 may be transmitted to the NAT gateway 1038 that can make the call to public Internet 1054. Metadata that may be desired to be stored by the request can be stored in the DB subnet(s) 1030.

In some examples, the data plane mirror app tier 1040 can facilitate direct communication between the control plane VCN 1016 and the data plane VCN 1018. For example, changes, updates, or other suitable modifications to configuration may be desired to be applied to the resources contained in the data plane VCN 1018. Via a VNIC 1042, the control plane VCN 1016 can directly communicate with, and can thereby execute the changes, updates, or other suitable modifications to configuration to, resources contained in the data plane VCN 1018.

In some embodiments, the control plane VCN 1016 and the data plane VCN 1018 can be contained in the service tenancy 1019. In this case, the user, or the customer, of the system may not own or operate either the control plane VCN 1016 or the data plane VCN 1018. Instead, the IaaS provider may own or operate the control plane VCN 1016 and the data plane VCN 1018, both of which may be contained in the service tenancy 1019. This embodiment can enable isolation of networks that may prevent users or customers from interacting with other users', or other customers', resources. Also, this embodiment may allow users or customers of the system to store databases privately without needing to rely on public Internet 1054, which may not have a desired level of threat prevention, for storage.

In other embodiments, the LB subnet(s) 1022 contained in the control plane VCN 1016 can be configured to receive a signal from the service gateway 1036. In this embodiment, the control plane VCN 1016 and the data plane VCN 1018 may be configured to be called by a customer of the IaaS provider without calling public Internet 1054. Customers of the IaaS provider may desire this embodiment since database(s) that the customers use may be controlled by the IaaS provider and may be stored on the service tenancy 1019, which may be isolated from public Internet 1054.

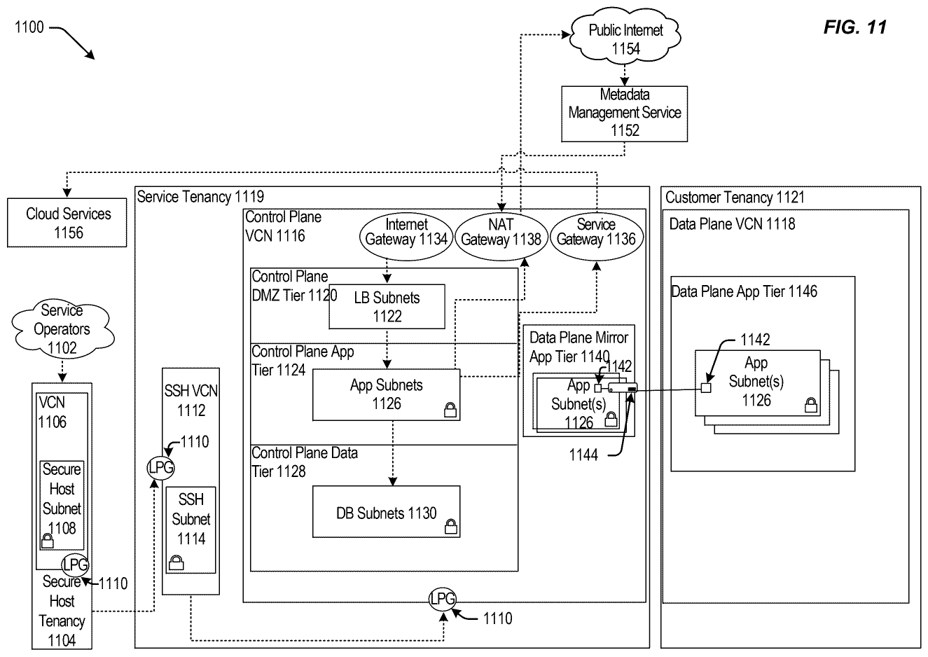

FIG. 11 is a block diagram 1100 illustrating another example pattern of an IaaS architecture, according to at least one embodiment. Service operators 1102 (e.g., service operators 1002 of FIG. 10) can be communicatively coupled to a secure host tenancy 1104 (e.g., the secure host tenancy 1004 of FIG. 10) that can include a virtual cloud network (VCN) 1106 (e.g., the VCN 1006 of FIG. 10) and a secure host subnet 1108 (e.g., the secure host subnet 1008 of FIG. 10). The VCN 1106 can include a local peering gateway (LPG) 1110 (e.g., the LPG 1010 of FIG. 10) that can be communicatively coupled to a secure shell (SSH) VCN 1112 (e.g., the SSH VCN 1012 of FIG. 10) via an LPG 1010 contained in the SSH VCN 1112. The SSH VCN 1112 can include an SSH subnet 1114 (e.g., the SSH subnet 1014 of FIG. 10), and the SSH VCN 1112 can be communicatively coupled to a control plane VCN 1116 (e.g., the control plane VCN 1016 of FIG. 10) via an LPG 1110 contained in the control plane VCN 1116. The control plane VCN 1116 can be contained in a service tenancy 1119 (e.g., the service tenancy 1019 of FIG. 10), and the data plane VCN 1118 (e.g., the data plane VCN 1018 of FIG. 10) can be contained in a customer tenancy 1121 that may be owned or operated by users, or customers, of the system.

The control plane VCN 1116 can include a control plane DMZ tier 1120 (e.g., the control plane DMZ tier 1020 of FIG. 10) that can include LB subnet(s) 1122 (e.g., LB subnet(s) 1022 of FIG. 10), a control plane app tier 1124 (e.g., the control plane app tier 1024 of FIG. 10) that can include app subnet(s) 1126 (e.g., app subnet(s) 1026 of FIG. 10), a control plane data tier 1128 (e.g., the control plane data tier 1028 of FIG. 10) that can include database (DB) subnet(s) 1130 (e.g., similar to DB subnet(s) 1030 of FIG. 10). The LB subnet(s) 1122 contained in the control plane DMZ tier 1120 can be communicatively coupled to the app subnet(s) 1126 contained in the control plane app tier 1124 and an Internet gateway 1134 (e.g., the Internet gateway 1034 of FIG. 10) that can be contained in the control plane VCN 1116, and the app subnet(s) 1126 can be communicatively coupled to the DB subnet(s) 1130 contained in the control plane data tier 1128 and a service gateway 1136 (e.g., the service gateway 1036 of FIG. 10) and a network address translation (NAT) gateway 1138 (e.g., the NAT gateway 1038 of FIG. 10). The control plane VCN 1116 can include the service gateway 1136 and the NAT gateway 1138.

The control plane VCN 1116 can include a data plane mirror app tier 1140 (e.g., the data plane mirror app tier 1040 of FIG. 10) that can include app subnet(s) 1126. The app subnet(s) 1126 contained in the data plane mirror app tier 1140 can include a virtual network interface controller (VNIC) 1142 (e.g., the VNIC of 1042) that can execute a compute instance 1144 (e.g., similar to the compute instance 1044 of FIG. 10). The compute instance 1144 can facilitate communication between the app subnet(s) 1126 of the data plane mirror app tier 1140 and the app subnet(s) 1126 that can be contained in a data plane app tier 1146 (e.g., the data plane app tier 1046 of FIG. 10) via the VNIC 1142 contained in the data plane mirror app tier 1140 and the VNIC 1142 contained in the data plane app tier 1146.

The Internet gateway 1134 contained in the control plane VCN 1116 can be communicatively coupled to a metadata management service 1152 (e.g., the metadata management service 1052 of FIG. 10) that can be communicatively coupled to public Internet 1154 (e.g., public Internet 1054 of FIG. 10). Public Internet 1154 can be communicatively coupled to the NAT gateway 1138 contained in the control plane VCN 1116. The service gateway 1136 contained in the control plane VCN 1116 can be communicatively coupled to cloud services 1156 (e.g., cloud services 1056 of FIG. 10).

In some examples, the data plane VCN 1118 can be contained in the customer tenancy 1121. In this case, the IaaS provider may provide the control plane VCN 1116 for each customer, and the IaaS provider may, for each customer, set up a unique compute instance 1144 that is contained in the service tenancy 1119. Each compute instance 1144 may allow communication between the control plane VCN 1116, contained in the service tenancy 1119, and the data plane VCN 1118 that is contained in the customer tenancy 1121. The compute instance 1144 may allow resources, that are provisioned in the control plane VCN 1116 that is contained in the service tenancy 1119, to be deployed or otherwise used in the data plane VCN 1118 that is contained in the customer tenancy 1121.

In other examples, the customer of the IaaS provider may have databases that live in the customer tenancy 1121. In this example, the control plane VCN 1116 can include the data plane mirror app tier 1140 that can include app subnet(s) 1126. The data plane mirror app tier 1140 can reside in the data plane VCN 1118, but the data plane mirror app tier 1140 may not live in the data plane VCN 1118. That is, the data plane mirror app tier 1140 may have access to the customer tenancy 1121, but the data plane mirror app tier 1140 may not exist in the data plane VCN 1118 or be owned or operated by the customer of the IaaS provider. The data plane mirror app tier 1140 may be configured to make calls to the data plane VCN 1118 but may not be configured to make calls to any entity contained in the control plane VCN 1116. The customer may desire to deploy or otherwise use resources in the data plane VCN 1118 that are provisioned in the control plane VCN 1116, and the data plane mirror app tier 1140 can facilitate the desired deployment, or other usage of resources, of the customer.

In some embodiments, the customer of the IaaS provider can apply filters to the data plane VCN 1118. In this embodiment, the customer can determine what the data plane VCN 1118 can access, and the customer may restrict access to public Internet 1154 from the data plane VCN 1118. The IaaS provider may not be able to apply filters or otherwise control access of the data plane VCN 1118 to any outside networks or databases. Applying filters and controls by the customer onto the data plane VCN 1118, contained in the customer tenancy 1121, can help isolate the data plane VCN 1118 from other customers and from public Internet 1154.

In some embodiments, cloud services 1156 can be called by the service gateway 1136 to access services that may not exist on public Internet 1154, on the control plane VCN 1116, or on the data plane VCN 1118. The connection between cloud services 1156 and the control plane VCN 1116 or the data plane VCN 1118 may not be live or continuous. Cloud services 1156 may exist on a different network owned or operated by the IaaS provider. Cloud services 1156 may be configured to receive calls from the service gateway 1136 and may be configured to not receive calls from public Internet 1154. Some cloud services 1156 may be isolated from other cloud services 1156, and the control plane VCN 1116 may be isolated from cloud services 1156 that may not be in the same region as the control plane VCN 1116. For example, the control plane VCN 1116 may be located in “Region 1,” and cloud service “Deployment 7,” may be located in Region 1 and in “Region 2.” If a call to Deployment 7 is made by the service gateway 1136 contained in the control plane VCN 1116 located in Region 1, the call may be transmitted to Deployment 7 in Region 1. In this example, the control plane VCN 1116, or Deployment 7 in Region 1, may not be communicatively coupled to, or otherwise in communication with, Deployment 7 in Region 2.

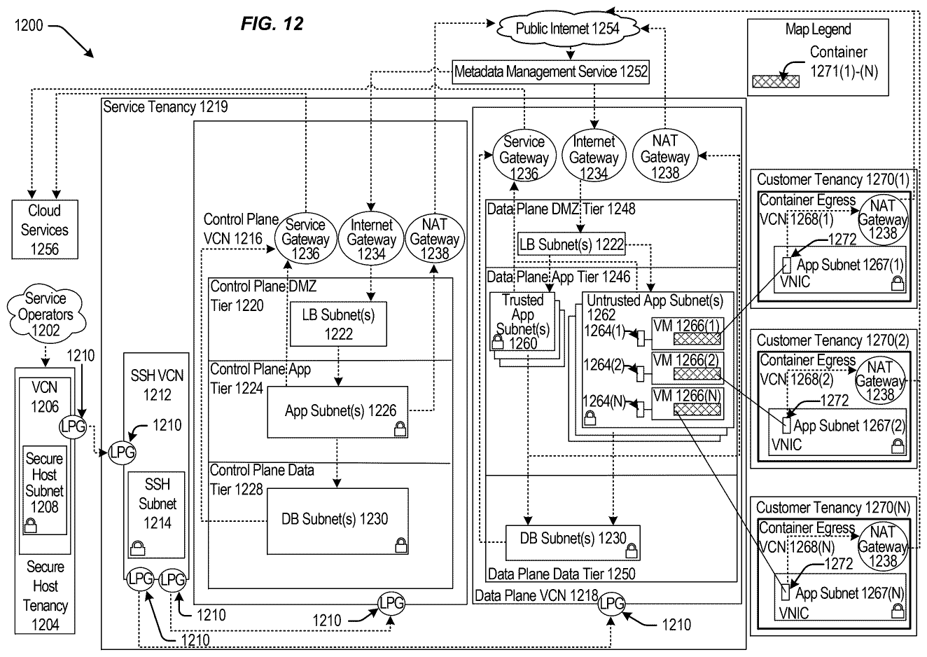

FIG. 12 is a block diagram 1200 illustrating another example pattern of an IaaS architecture, according to at least one embodiment. Service operators 1202 (e.g., service operators 1002 of FIG. 10) can be communicatively coupled to a secure host tenancy 1204 (e.g., the secure host tenancy 1004 of FIG. 10) that can include a virtual cloud network (VCN) 1206 (e.g., the VCN 1006 of FIG. 10) and a secure host subnet 1208 (e.g., the secure host subnet 1008 of FIG. 10). The VCN 1206 can include an LPG 1210 (e.g., the LPG 1010 of FIG. 10) that can be communicatively coupled to an SSH VCN 1212 (e.g., the SSH VCN 1012 of FIG. 10) via an LPG 1210 contained in the SSH VCN 1212. The SSH VCN 1212 can include an SSH subnet 1214 (e.g., the SSH subnet 1014 of FIG. 10), and the SSH VCN 1212 can be communicatively coupled to a control plane VCN 1216 (e.g., the control plane VCN 1016 of FIG. 10) via an LPG 1210 contained in the control plane VCN 1216 and to a data plane VCN 1218 (e.g., the data plane 1018 of FIG. 10) via an LPG 1210 contained in the data plane VCN 1218. The control plane VCN 1216 and the data plane VCN 1218 can be contained in a service tenancy 1219 (e.g., the service tenancy 1019 of FIG. 10).

The control plane VCN 1216 can include a control plane DMZ tier 1220 (e.g., the control plane DMZ tier 1020 of FIG. 10) that can include load balancer (LB) subnet(s) 1222 (e.g., LB subnet(s) 1022 of FIG. 10), a control plane app tier 1224 (e.g., the control plane app tier 1024 of FIG. 10) that can include app subnet(s) 1226 (e.g., similar to app subnet(s) 1026 of FIG. 10), a control plane data tier 1228 (e.g., the control plane data tier 1028 of FIG. 10) that can include DB subnet(s) 1230. The LB subnet(s) 1222 contained in the control plane DMZ tier 1220 can be communicatively coupled to the app subnet(s) 1226 contained in the control plane app tier 1224 and to an Internet gateway 1234 (e.g., the Internet gateway 1034 of FIG. 10) that can be contained in the control plane VCN 1216, and the app subnet(s) 1226 can be communicatively coupled to the DB subnet(s) 1230 contained in the control plane data tier 1228 and to a service gateway 1236 (e.g., the service gateway of FIG. 10) and a network address translation (NAT) gateway 1238 (e.g., the NAT gateway 1038 of FIG. 10). The control plane VCN 1216 can include the service gateway 1236 and the NAT gateway 1238.

The data plane VCN 1218 can include a data plane app tier 1246 (e.g., the data plane app tier 1046 of FIG. 10), a data plane DMZ tier 1248 (e.g., the data plane DMZ tier 1048 of FIG. 10), and a data plane data tier 1250 (e.g., the data plane data tier 1050 of FIG. 10). The data plane DMZ tier 1248 can include LB subnet(s) 1222 that can be communicatively coupled to trusted app subnet(s) 1260 and untrusted app subnet(s) 1262 of the data plane app tier 1246 and the Internet gateway 1234 contained in the data plane VCN 1218. The trusted app subnet(s) 1260 can be communicatively coupled to the service gateway 1236 contained in the data plane VCN 1218, the NAT gateway 1238 contained in the data plane VCN 1218, and DB subnet(s) 1230 contained in the data plane data tier 1250. The untrusted app subnet(s) 1262 can be communicatively coupled to the service gateway 1236 contained in the data plane VCN 1218 and DB subnet(s) 1230 contained in the data plane data tier 1250. The data plane data tier 1250 can include DB subnet(s) 1230 that can be communicatively coupled to the service gateway 1236 contained in the data plane VCN 1218.

The untrusted app subnet(s) 1262 can include one or more primary VNICs 1264(1)-(N) that can be communicatively coupled to tenant virtual machines (VMs) 1266(1)-(N). Each tenant VM 1266(1)-(N) can be communicatively coupled to a respective app subnet 1267(1)-(N) that can be contained in respective container egress VCNs 1268(1)-(N) that can be contained in respective customer tenancies 1270(1)-(N). Respective secondary VNICs 1272(1)-(N) can facilitate communication between the untrusted app subnet(s) 1262 contained in the data plane VCN 1218 and the app subnet contained in the container egress VCNs 1268(1)-(N). Each container egress VCNs 1268(1)-(N) can include a NAT gateway 1238 that can be communicatively coupled to public Internet 1254 (e.g., public Internet 1054 of FIG. 10).

The Internet gateway 1234 contained in the control plane VCN 1216 and contained in the data plane VCN 1218 can be communicatively coupled to a metadata management service 1252 (e.g., the metadata management system 1052 of FIG. 10) that can be communicatively coupled to public Internet 1254. Public Internet 1254 can be communicatively coupled to the NAT gateway 1238 contained in the control plane VCN 1216 and contained in the data plane VCN 1218. The service gateway 1236 contained in the control plane VCN 1216 and contained in the data plane VCN 1218 can be communicatively coupled to cloud services 1256.

In some embodiments, the data plane VCN 1218 can be integrated with customer tenancies 1270. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1246. Code to run the function may be executed in the VMs 1266(1)-(N), and the code may not be configured to run anywhere else on the data plane VCN 1218. Each VM 1266(1)-(N) may be connected to one customer tenancy 1270. Respective containers 1271(1)-(N) contained in the VMs 1266(1)-(N) may be configured to run the code. In this case, there can be a dual isolation (e.g., the containers 1271(1)-(N) running code, where the containers 1271(1)-(N) may be contained in at least the VM 1266(1)-(N) that are contained in the untrusted app subnet(s) 1262), which may help prevent incorrect or otherwise undesirable code from damaging the network of the IaaS provider or from damaging a network of a different customer. The containers 1271(1)-(N) may be communicatively coupled to the customer tenancy 1270 and may be configured to transmit or receive data from the customer tenancy 1270. The containers 1271(1)-(N) may not be configured to transmit or receive data from any other entity in the data plane VCN 1218. Upon completion of running the code, the IaaS provider may kill or otherwise dispose of the containers 1271(1)-(N).

In some embodiments, the trusted app subnet(s) 1260 may run code that may be owned or operated by the IaaS provider. In this embodiment, the trusted app subnet(s) 1260 may be communicatively coupled to the DB subnet(s) 1230 and be configured to execute CRUD operations in the DB subnet(s) 1230. The untrusted app subnet(s) 1262 may be communicatively coupled to the DB subnet(s) 1230, but in this embodiment, the untrusted app subnet(s) may be configured to execute read operations in the DB subnet(s) 1230. The containers 1271(1)-(N) that can be contained in the VM 1266(1)-(N) of each customer and that may run code from the customer may not be communicatively coupled with the DB subnet(s) 1230.

In other embodiments, the control plane VCN 1216 and the data plane VCN 1218 may not be directly communicatively coupled. In this embodiment, there may be no direct communication between the control plane VCN 1216 and the data plane VCN 1218. However, communication can occur indirectly through at least one method. An LPG 1210 may be established by the IaaS provider that can facilitate communication between the control plane VCN 1216 and the data plane VCN 1218. In another example, the control plane VCN 1216 or the data plane VCN 1218 can make a call to cloud services 1256 via the service gateway 1236. For example, a call to cloud services 1256 from the control plane VCN 1216 can include a request for a service that can communicate with the data plane VCN 1218.

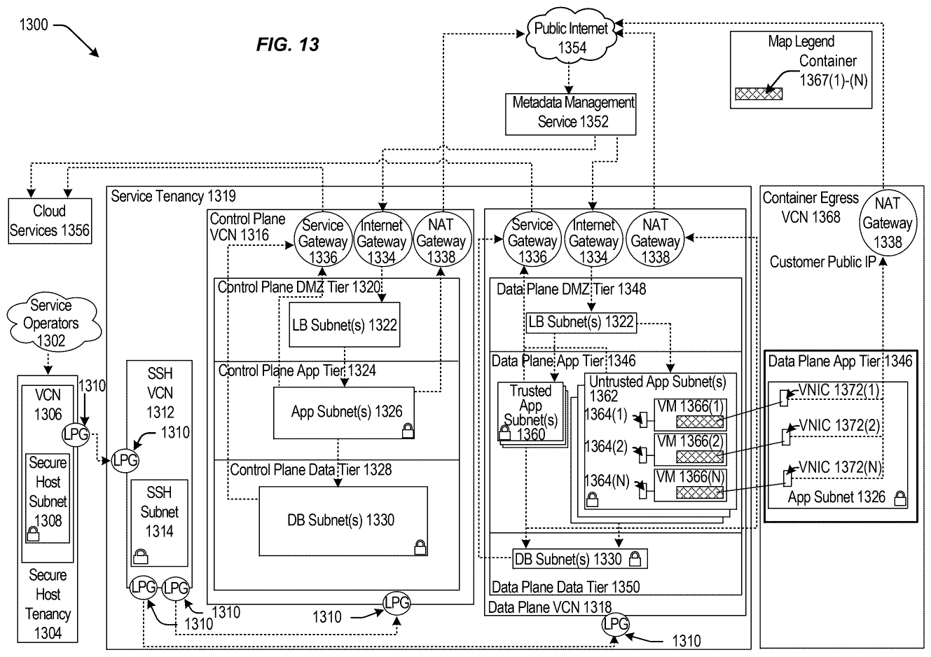

FIG. 13 is a block diagram 1300 illustrating another example pattern of an IaaS architecture, according to at least one embodiment. Service operators 1302 (e.g., service operators 1002 of FIG. 10) can be communicatively coupled to a secure host tenancy 1304 (e.g., the secure host tenancy 1004 of FIG. 10) that can include a virtual cloud network (VCN) 1306 (e.g., the VCN 1006 of FIG. 10) and a secure host subnet 1308 (e.g., the secure host subnet 1008 of FIG. 10). The VCN 1306 can include an LPG 1310 (e.g., the LPG 1010 of FIG. 10) that can be communicatively coupled to an SSH VCN 1312 (e.g., the SSH VCN 1012 of FIG. 10) via an LPG 1310 contained in the SSH VCN 1312. The SSH VCN 1312 can include an SSH subnet 1314 (e.g., the SSH subnet 1014 of FIG. 10), and the SSH VCN 1312 can be communicatively coupled to a control plane VCN 1316 (e.g., the control plane VCN 1016 of FIG. 10) via an LPG 1310 contained in the control plane VCN 1316 and to a data plane VCN 1318 (e.g., the data plane 1018 of FIG. 10) via an LPG 1310 contained in the data plane VCN 1318. The control plane VCN 1316 and the data plane VCN 1318 can be contained in a service tenancy 1319 (e.g., the service tenancy 1019 of FIG. 10).

The control plane VCN 1316 can include a control plane DMZ tier 1320 (e.g., the control plane DMZ tier 1020 of FIG. 10) that can include LB subnet(s) 1322 (e.g., LB subnet(s) 1022 of FIG. 10), a control plane app tier 1324 (e.g., the control plane app tier 1024 of FIG. 10) that can include app subnet(s) 1326 (e.g., app subnet(s) 1026 of FIG. 10), a control plane data tier 1328 (e.g., the control plane data tier 1028 of FIG. 10) that can include DB subnet(s) 1330 (e.g., DB subnet(s) 1230 of FIG. 12). The LB subnet(s) 1322 contained in the control plane DMZ tier 1320 can be communicatively coupled to the app subnet(s) 1326 contained in the control plane app tier 1324 and to an Internet gateway 1334 (e.g., the Internet gateway 1034 of FIG. 10) that can be contained in the control plane VCN 1316, and the app subnet(s) 1326 can be communicatively coupled to the DB subnet(s) 1330 contained in the control plane data tier 1328 and to a service gateway 1336 (e.g., the service gateway of FIG. 10) and a network address translation (NAT) gateway 1338 (e.g., the NAT gateway 1038 of FIG. 10). The control plane VCN 1316 can include the service gateway 1336 and the NAT gateway 1338.

The data plane VCN 1318 can include a data plane app tier 1346 (e.g., the data plane app tier 1046 of FIG. 10), a data plane DMZ tier 1348 (e.g., the data plane DMZ tier 1048 of FIG. 10), and a data plane data tier 1350 (e.g., the data plane data tier 1050 of FIG. 10). The data plane DMZ tier 1348 can include LB subnet(s) 1322 that can be communicatively coupled to trusted app subnet(s) 1360 (e.g., trusted app subnet(s) 1260 of FIG. 12) and untrusted app subnet(s) 1362 (e.g., untrusted app subnet(s) 1262 of FIG. 12) of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include primary VNICs 1364(1)-(N) that can be communicatively coupled to tenant virtual machines (VMs) 1366(1)-(N) residing within the untrusted app subnet(s) 1362. Each tenant VM 1366(1)-(N) can run code in a respective container 1367(1)-(N), and be communicatively coupled to an app subnet 1326 that can be contained in a data plane app tier 1346 that can be contained in a container egress VCN 1368. Respective secondary VNICs 1372(1)-(N) can facilitate communication between the untrusted app subnet(s) 1362 contained in the data plane VCN 1318 and the app subnet contained in the container egress VCN 1368. The container egress VCN can include a NAT gateway 1338 that can be communicatively coupled to public Internet 1354 (e.g., public Internet 1054 of FIG. 10).

The Internet gateway 1334 contained in the control plane VCN 1316 and contained in the data plane VCN 1318 can be communicatively coupled to a metadata management service 1352 (e.g., the metadata management system 1052 of FIG. 10) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively coupled to cloud services 1356.

In some examples, the pattern illustrated by the architecture of block diagram 1300 of FIG. 13 may be considered an exception to the pattern illustrated by the architecture of block diagram 1200 of FIG. 12 and may be desirable for a customer of the IaaS provider if the IaaS provider cannot directly communicate with the customer (e.g., a disconnected region). The respective containers 1367(1)-(N) that are contained in the VMs 1366(1)-(N) for each customer can be accessed in real-time by the customer. The containers 1367(1)-(N) may be configured to make calls to respective secondary VNICs 1372(1)-(N) contained in app subnet(s) 1326 of the data plane app tier 1346 that can be contained in the container egress VCN 1368. The secondary VNICs 1372(1)-(N) can transmit the calls to the NAT gateway 1338 that may transmit the calls to public Internet 1354. In this example, the containers 1367(1)-(N) that can be accessed in real-time by the customer can be isolated from the control plane VCN 1316 and can be isolated from other entities contained in the data plane VCN 1318. The containers 1367(1)-(N) may also be isolated from resources from other customers.

In other examples, the customer can use the containers 1367(1)-(N) to call cloud services 1356. In this example, the customer may run code in the containers 1367(1)-(N) that requests a service from cloud services 1356. The containers 1367(1)-(N) can transmit this request to the secondary VNICs 1372(1)-(N) that can transmit the request to the NAT gateway that can transmit the request to public Internet 1354. Public Internet 1354 can transmit the request to LB subnet(s) 1322 contained in the control plane VCN 1316 via the Internet gateway 1334. In response to determining the request is valid, the LB subnet(s) can transmit the request to app subnet(s) 1326 that can transmit the request to cloud services 1356 via the service gateway 1336.

It should be appreciated that IaaS architectures 1000, 1100, 1200, 1300 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

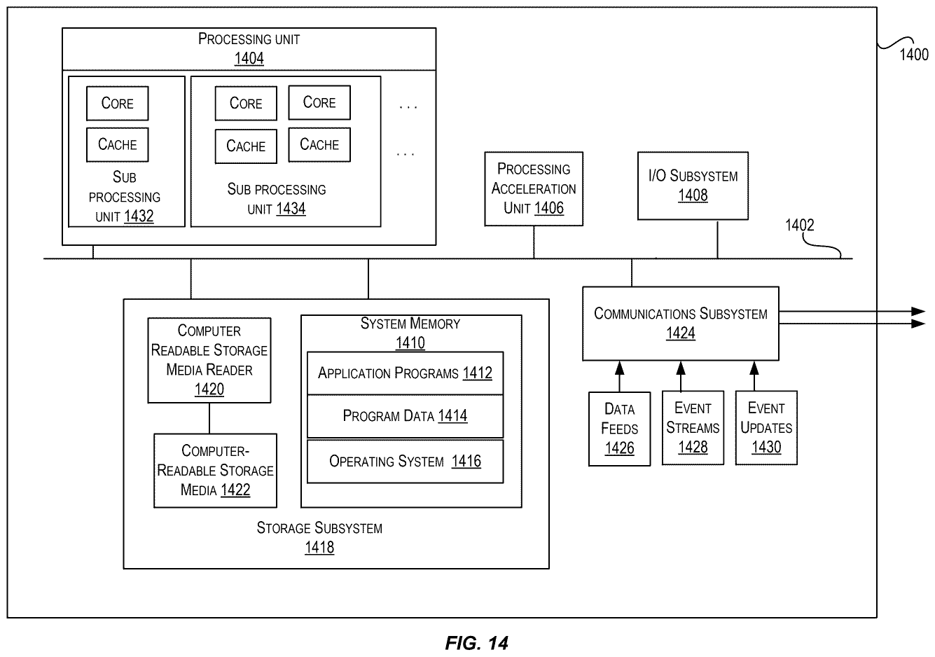

FIG. 14 illustrates an example computer system 1400, in which various embodiments may be implemented. The system 1400 may be used to implement any of the computer systems described above. As shown in the figure, computer system 1400 includes a processing unit 1404 that communicates with a number of peripheral subsystems via a bus subsystem 1402. These peripheral subsystems may include a processing acceleration unit 1406, an I/O subsystem 1408, a storage subsystem 1418 and a communications subsystem 1424. Storage subsystem 1418 includes tangible computer-readable storage media 1422 and a system memory 1410.

Bus subsystem 1402 provides a mechanism for letting the various components and subsystems of computer system 1400 communicate with each other as intended. Although bus subsystem 1402 is shown schematically as a single bus, alternative embodiments of the bus subsystem may utilize multiple buses. Bus subsystem 1402 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1404, which can be implemented as one or more integrated circuits (e.g., a conventional microprocessor or microcontroller), controls the operation of computer system 1400. One or more processors may be included in processing unit 1404. These processors may include single core or multicore processors. In certain embodiments, processing unit 1404 may be implemented as one or more independent processing units 1432 and/or 1434 with single or multicore processors included in each processing unit. In other embodiments, processing unit 1404 may also be implemented as a quad-core processing unit formed by integrating two dual-core processors into a single chip.

In various embodiments, processing unit 1404 can execute a variety of programs in response to program code and can maintain multiple concurrently executing programs or processes. At any given time, some, or all of the program code to be executed can be resident in processor(s) 1404 and/or in storage subsystem 1418. Through suitable programming, processor(s) 1404 can provide various functionalities described above. Computer system 1400 may additionally include a processing acceleration unit 1406, which can include a digital signal processor (DSP), a special-purpose processor, and/or the like.

I/O subsystem 1408 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1400 to a user or other computer. For example, user interface output devices may include, without limitation, a variety of display devices that visually convey text, graphics, and audio/video information such as monitors, printers, speakers, headphones, automotive navigation systems, plotters, voice output devices, and modems.

Computer system 1400 may comprise a storage subsystem 1418 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1404 provide the functionality described above. Storage subsystem 1418 may also provide a repository for storing data used in accordance with the present disclosure.

As depicted in the example in FIG. 14, storage subsystem 1418 can include various components including a system memory 1410, computer-readable storage media 1422, and a computer readable storage media reader 1420. System memory 1410 may store program instructions that are loadable and executable by processing unit 1404. System memory 1410 may also store data that is used during the execution of the instructions and/or data that is generated during the execution of the program instructions. Various different kinds of programs may be loaded into system memory 1410 including but not limited to client applications, Web browsers, mid-tier applications, relational database management systems (RDBMS), virtual machines, containers, etc.

System memory 1410 may also store an operating system 1416. Examples of operating system 1416 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1400 executes one or more virtual machines, the virtual machines along with their guest operating systems (GOSs) may be loaded into system memory 1410 and executed by one or more processors or cores of processing unit 1404.

System memory 1410 can come in different configurations depending upon the type of computer system 1400. For example, system memory 1410 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1410 may include a basic input/output system (BIOS) containing basic routines that help to transfer information between elements within computer system 1400, such as during start-up.

Computer-readable storage media 1422 may represent remote, local, fixed, and/or removable storage devices plus storage media for temporarily and/or more permanently containing, storing, computer-readable information for use by computer system 1400 including instructions executable by processing unit 1404 of computer system 1400.

Computer-readable storage media 1422 can include any appropriate media known or used in the art, including storage media and communication media, such as but not limited to, volatile and non-volatile, removable, and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1422 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1422 may include, but is not limited to, Zip® drives, flash memory cards, universal serial bus (USB) flash drives, secure digital (SD) cards, DVD disks, digital video tape, and the like. Computer-readable storage media 1422 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1400.

Machine-readable instructions executable by one or more processors or cores of processing unit 1404 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1424 provides an interface to other computer systems and networks. Communications subsystem 1424 serves as an interface for receiving data from and transmitting data to other systems from computer system 1400. For example, communications subsystem 1424 may enable computer system 1400 to connect to one or more devices via the Internet. In some embodiments communications subsystem 1424 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1424 can provide wired network connectivity (e.g., Ethernet) in addition to or instead of a wireless interface.

In some embodiments, communications subsystem 1424 may also receive input communication in the form of structured and/or unstructured data feeds 1426, event streams 1428, event updates 1430, and the like on behalf of one or more users who may use computer system 1400.

By way of example, communications subsystem 1424 may be configured to receive data feeds 1426 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1424 may also be configured to receive data in the form of continuous data streams, which may include event streams 1428 of real-time events and/or event updates 1430, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1424 may also be configured to output the structured and/or unstructured data feeds 1426, event streams 1428, event updates 1430, and the like to one or more databases that may be in communication with one or more streaming data source computers coupled to computer system 1400.

Computer system 1400 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1400 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising
accessing customization information comprising a set of reference natural language queries;
generating, by one or more first generative artificial intelligence models, a set of synthetic natural language queries based on the customization information and database schema information, wherein each synthetic natural language query of the set of synthetic natural language queries is an augmented version of a reference natural language query of the set of reference natural language queries;
generating, by one or more second generative artificial intelligence models, a set of distillation training examples based on the set of synthetic natural language queries, wherein generating the set of distillation training examples comprises:
generating a synthetic programming language query for each synthetic natural language query of the set of synthetic natural language queries, and
generating each distillation training example of the set of distillation training examples such that each distillation training example comprises: (i) a synthetic natural language query, (ii) a database schema from the database schema information associated with the synthetic natural language query, and (iii) a synthetic programming language query corresponding with the synthetic natural language query; and
training a machine learning model with the set of distillation training examples to generate a trained machine learning model.

2. The computer-implemented method of claim 1, wherein generating the set of synthetic natural language queries comprises:
extracting a subset of reference natural language queries from the set of reference natural language queries;
identifying a training database schema based on the database schema information;
generating a first prompt comprising the subset of reference natural language queries, a target question, the training database schema, and a natural language query generation instruction; and
providing the first prompt as an input to the one or more first generative artificial intelligence models.

3. The computer-implemented method of claim 2, wherein the first prompt further comprises an irrelevant natural language query associated with one or more irrelevant training examples.

4. The computer-implemented method of claim 2, wherein generating a synthetic programming language query for each synthetic natural language query comprises:
constructing a second prompt, wherein the second prompt comprises a synthetic natural language query of the set of synthetic natural language queries, a database schema associated with the synthetic natural language query, and a programming language query generation instruction;
generating, based on the second prompt and using the one or more second generative artificial intelligence models, the synthetic programming language query associated with the synthetic natural language query; and
generating a description of the synthetic programming language query.

5. The computer-implemented method of claim 1, further comprising, prior to training the machine learning model, filtering the set of distillation training examples to generate a filtered set of distillation training examples, wherein the filtering comprises:
performing pattern-based filtering on the set of distillation training examples, wherein the pattern-based filtering comprises removing, from the set of distillation training examples, one or more distillation training examples comprising a synthetic programming language query with a syntax error;
performing execution-based filtering on the set of distillation training examples, wherein the execution-based filtering, for each distillation training example of the set of distillation training examples, comprises:
executing a synthetic programming language query included in the distillation training example on a database, and
when executing the synthetic programming language query on the database fails, removing the distillation training example from the set of distillation training examples; and
performing quality evaluation filtering, by one or more third generative artificial intelligence models, on the set of distillation training examples, wherein the quality evaluation filtering comprises performing a quality evaluation on each distillation training example of the set of distillation training examples and removing one or more irrelevant training examples from the distillation dataset,
wherein the filtered set of distillation training examples is used to train the machine learning model.

6. The computer-implemented method of claim 5, wherein the quality evaluation comprises:
determining, by the one or more third generative artificial intelligence models, a correctness score for the synthetic programming language query based on the synthetic natural language query; and
determining a relevance of the distillation training example based on the set of reference natural language queries.

7. The computer-implemented of claim 1, further comprising:
receiving an input from a user, the input comprising a natural language component;
converting the input into a prompt, wherein the prompt comprises an instruction, a database schema associated with the natural language component, and an utterance associated with the natural language component;
transmitting the prompt to the trained machine learning model;
receiving, from the trained machine learning model, a programming language query corresponding to the utterance based at least in part on the prompt;
executing the programming language query on a database to obtain a query result; and
providing the query result to the user.

8. A system comprising:
one or more processors; and
one or more computer-readable media storing instructions which, when executed by the one or more processors, cause the system to perform operations comprising:
accessing customization information comprising a set of reference natural language queries;
generating, by one or more first generative artificial intelligence models, a set of synthetic natural language queries based on the customization information and database schema information, wherein each synthetic natural language query of the set of synthetic natural language queries is an augmented version of a reference natural language query of the set of reference natural language queries;
generating, by one or more second generative artificial intelligence models, a set of distillation training examples based on the set of synthetic natural language queries, wherein generating the set of distillation training examples comprises:
generating a synthetic programming language query for each synthetic natural language query of the set of synthetic natural language queries, and
generating each distillation training example of the set of distillation training examples such that each distillation training example comprises: (i) a synthetic natural language query, (ii) a database schema from the database schema information associated with the synthetic natural language query, and (iii) a synthetic programming language query corresponding with the synthetic natural language query; and
training a machine learning model with the set of distillation training examples to generate a trained machine learning model.

9. The system of claim 8, wherein generating the set of synthetic natural language queries comprises:
extracting a subset of reference natural language queries from the set of reference natural language queries;
identifying a training database schema based on the database schema information;
generating a first prompt comprising the subset of reference natural language queries, a target question, the training database schema, and a natural language query generation instruction; and
providing the first prompt as an input to the one or more first generative artificial intelligence models.

10. The system of claim 9, wherein the first prompt further comprises an irrelevant natural language query associated with one or more irrelevant training examples.

11. The system of claim 9, wherein generating a synthetic programming language query for each synthetic natural language query comprises:
constructing a second prompt, wherein the second prompt comprises a synthetic natural language query of the set of synthetic natural language queries, a database schema associated with the synthetic natural language query, and a programming language query generation instruction;
generating, based on the second prompt and using the one or more second generative artificial intelligence models, the synthetic programming language query associated with the synthetic natural language query; and
generating a description of the synthetic programming language query.

12. The system of claim 8, wherein the operations further comprise, prior to training the machine learning model, filtering the set of distillation training examples to generate a filtered set of distillation training examples, wherein the filtering comprises:
performing pattern-based filtering on the set of distillation training examples, wherein the pattern-based filtering comprises removing, from the set of distillation training examples, one or more distillation training examples comprising a synthetic programming language query with a syntax error;
performing execution-based filtering on the set of distillation training examples, wherein the execution-based filtering, for each distillation training example of the set of distillation training examples, comprises:
executing a synthetic programming language query included in the distillation training example on a database, and
when executing the synthetic programming language query on the database fails, removing the distillation training example from the set of distillation training examples; and
performing quality evaluation filtering, by one or more third generative artificial intelligence models, on the set of distillation training examples, wherein the quality evaluation filtering comprises performing a quality evaluation on each distillation training example of the set of distillation training examples and removing one or more irrelevant training examples from the distillation dataset,
wherein the filtered set of distillation training examples is used to train the machine learning model.

13. The system of claim 12, wherein the quality evaluation comprises:
determining, by the one or more third generative artificial intelligence models, a correctness score for the synthetic programming language query based on the synthetic natural language query; and
determining a relevance of the distillation training example based on the set of reference natural language queries.

14. The system of claim 8, wherein the operations further comprise:
receiving an input from a user, the input comprising a natural language component;
converting the input into a prompt, wherein the prompt comprises an instruction, a database schema associated with the natural language component, and an utterance associated with the natural language component;
transmitting the prompt to the trained machine learning model;
receiving, from the trained machine learning model, a programming language query corresponding to the utterance based at least in part on the prompt;
executing the programming language query on a database to obtain a query result; and
providing the query result to the user.

15. One or more non-transitory computer-readable media storing instructions which, when executed by one or more processors, cause the one or more processors to perform operations comprising:
accessing customization information comprising a set of reference natural language queries;
generating, by one or more first generative artificial intelligence models, a set of synthetic natural language queries based on the customization information and database schema information, wherein each synthetic natural language query of the set of synthetic natural language queries is an augmented version of a reference natural language query of the set of reference natural language queries;
generating, by one or more second generative artificial intelligence models, a set of distillation training examples based on the set of synthetic natural language queries, wherein generating the set of distillation training examples comprises:
generating a synthetic programming language query for each synthetic natural language query of the set of synthetic natural language queries, and
generating each distillation training example of the set of distillation training examples such that each distillation training example comprises: (i) a synthetic natural language query, (ii) a database schema from the database schema information associated with the synthetic natural language query, and (iii) a synthetic programming language query corresponding with the synthetic natural language query; and
training a machine learning model with the set of distillation training examples to generate a trained machine learning model.

16. The one or more non-transitory computer-readable media of claim 15, wherein generating the set of synthetic natural language queries comprises:
extracting a subset of reference natural language queries from the set of reference natural language queries;
identifying a training database schema based on the database schema information;
generating a first prompt comprising the subset of reference natural language queries, a target question, the training database schema, and a natural language query generation instruction; and
providing the first prompt as an input to the one or more first generative artificial intelligence models.

17. The one or more non-transitory computer-readable media of claim 16, wherein the first prompt further comprises an irrelevant natural language query associated with one or more irrelevant training examples.

18. The one or more non-transitory computer-readable media of claim 16, wherein generating a synthetic programming language query for each synthetic natural language query comprises:
constructing a second prompt, wherein the second prompt comprises a synthetic natural language query of the set of synthetic natural language queries, a database schema associated with the synthetic natural language query, and a programming language query generation instruction;
generating, based on the second prompt and using the one or more second generative artificial intelligence models, the synthetic programming language query associated with the synthetic natural language query; and
generating a description of the synthetic programming language query.

19. The one or more non-transitory computer-readable media of claim 15, wherein the operations further comprise, prior to training the machine learning model, filtering the set of distillation training examples to generate a filtered set of distillation training examples, wherein the filtering comprises:
performing pattern-based filtering on the set of distillation training examples, wherein the pattern-based filtering comprises removing, from the set of distillation training examples, one or more distillation training examples comprising a synthetic programming language query with a syntax error;
performing execution-based filtering on the set of distillation training examples, wherein the execution-based filtering, for each distillation training example of the set of distillation training examples, comprises:
executing a synthetic programming language query included in the distillation training example on a database, and
when executing the synthetic programming language query on the database fails, removing the distillation training example from the set of distillation training examples; and
performing quality evaluation filtering, by one or more third generative artificial intelligence models, on the set of distillation training examples, wherein the quality evaluation filtering comprises performing a quality evaluation on each distillation training example of the set of distillation training examples and removing one or more irrelevant training examples from the distillation dataset,
wherein the filtered set of distillation training examples is used to train the machine learning model.

20. The one or more non-transitory computer-readable media of claim 15, wherein the operations further comprise:
receiving an input from a user, the input comprising a natural language component;
converting the input into a prompt, wherein the prompt comprises an instruction, a database schema associated with the natural language component, and an utterance associated with the natural language component;
transmitting the prompt to the trained machine learning model;
receiving, from the trained machine learning model, a programming language query corresponding to the utterance based at least in part on the prompt;
executing the programming language query on a database to obtain a query result; and
providing the query result to the user.
